(19) United States
(12) Patent Application Publication
(10) Pub. No.: US 2026/0202618 A1
(43) Pub. Date: Jul. 16, 2026

(54) OPTICAL SWITCH WITH MULTIMODE PHASE SHIFTER

(71) Applicant: Cisco Technology, Inc., San Jose, CA (US)

(72) Inventors: Jean-Luc J. TAMBASCO, Macungie, PA (US); Tao LING, Breinigsville, PA (US)

(21) Appl. No.: 19/020,998

(22) Filed: Jan. 14, 2025

(51) Int. Cl. G02B 6/28; G02B 6/26; G02F 1/21; G02F 1/225

(52) U.S. Cl. CPC G02B 6/2813; G02B 6/266; G02F 1/217; G02F 1/225

(57) ABSTRACT

An optical switch includes an input splitter, a phase shift section, and an output combiner. The input splitter splits a first optical signal input into a first single mode input onto first and second multimode outputs and splits a second optical signal input into a second single mode input onto the first and second multimode outputs. The phase shift section has a phase shifter and first and second multimode waveguides coupled with the first and second multimode outputs, respectively. The phase shifter selectively causes a multimode optical signal within the first multimode waveguide to undergo a phase shift relative to a multimode optical signal within the second multimode waveguide. The multimode optical signals each include portions of the first and second optical signals. The output combiner receives the multimode optical signals and recombines the first and second optical signals onto first and second single mode outputs, respectively.

### TECHNICAL FIELD

Aspects presented in this disclosure generally relate to optical switches, such as variable optical attenuators (VOAs) used in telecommunication systems.

### BACKGROUND

Optical switches, such as variable optical attenuators (VOAs), can be used to dynamically turn on, turn off, or adjust the strength of an optical signal traveling along an optical path of a telecommunication system. To turn on, turn off, or adjust the strength of an optical signal, electrical power can be delivered to a phase shifter so that the optical signal can be attenuated. Typically, each signal channel has one input and one output and is controlled by a dedicated phase shifter of a VOA, with the dedicated phase shifters being arranged to selectively phase shift respective signals. Further, in some instances it may be desirable to construct a VOA as a “normally on” or “normally off” switch. Some optical switch platforms can be formed of silicon. However, silicon platforms can have relatively high random phase noise (RPN) compared to other platform materials, making it challenging to ensure normally on/off behavior. Alternative materials for optical switch platforms have been contemplated, such as those that have relatively low RPN compared to silicon, but such materials can present additional challenges. For instance, such alternative materials can have a lower thermo-optic coefficient compared to silicon platforms, and thus, the electrical power to drive signal attenuation can be relatively high.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A depicts a schematic block diagram of an optical switch according to one or more aspects of the present disclosure.

FIGS. 1B, 1C, and 1D depict schematic block diagrams of the optical switch of FIG. 1A, with an optical signal being provided to a first single mode input of the input splitter in FIG. 1B, with an optical signal being provided to a second single mode input of the input splitter in FIG. 1C, and with a first optical signal being provided to the first single mode input of the input splitter and a second optical signal being provided to the second single mode input of the input splitter in FIG. 1D.

FIGS. 2-9 depict schematic block diagrams of various optical switches according to one or more aspects of the present disclosure.

FIGS. 10-14 depict schematic block diagrams of apparatuses according to one or more aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

In one aspect, an optical switch is disclosed. The optical switch includes an input splitter arranged to split a first optical signal input into a first single mode input onto first and second multimode outputs and to split a second optical signal input into a second single mode input onto the first and second multimode outputs. The optical switch also includes a phase shift section having a first multimode waveguide coupled with the first multimode output, a second multimode waveguide coupled with the second multimode output, and a phase shifter arranged to selectively cause a multimode optical signal traveling through the first multimode waveguide to undergo a phase shift relative to a multimode optical signal traveling through the second multimode waveguide, the multimode optical signals each including a portion of the first optical signal and a portion of the second optical signal. Also, the optical switch includes an output combiner arranged to receive the multimode optical signals from the first and second multimode waveguides and to recombine the first optical signal onto a first single mode output and to recombine the second optical signal onto a second single mode output.

In another aspect, an apparatus is disclosed. The apparatus includes a first multimode variable optical attenuator (MM-VOA) and a second MM-VOA. The first MM-VOA and the second MM-VOA each include: an input splitter arranged to split a first optical signal input into a first single mode input onto first and second multimode outputs and to split a second optical signal input into a second single mode input onto the first and second multimode outputs; a phase shift section that includes a first multimode waveguide coupled with the first multimode output, and a second multimode waveguide coupled with the second multimode output; and an output combiner arranged to recombine the first optical signal onto a first single mode output and to recombine the second optical signal onto a second single mode output. The apparatus further includes a phase shifter shared by the first MM-VOA and the second MM-VOA and arranged to selectively cause a multimode signal traveling through the first multimode waveguide of the first MM-VOA and a multimode signal traveling through the first multimode waveguide of second MM-VOA to each undergo a phase shift. The multimode signal traveling through the first multimode waveguide of the first MM-VOA including portions of the first and second optical signals input into the first and second single mode inputs of the first MM-VOA and the multimode signal traveling through the first multimode waveguide of the second MM-VOA including portions of the first and second optical signals input into the first and second single mode inputs of the second MM-VOA.

In a further aspect, an apparatus is disclosed. The apparatus includes a phase shifter, a first multimode variable optical attenuator (MM-VOA), and a second MM-VOA. The first MM-VOA and the second MM-VOA each include: a splitter-combiner having an input and an output; a phase shift section having a first multimode waveguide and a second multimode waveguide; and a combiner-splitter having an input and an output. Further, (i) the output of the combiner-splitter of the first MM-VOA is coupled with the input of the splitter-combiner of the second MM-VOA, (ii) the output of the splitter-combiner of the second MM-VOA is coupled with the input of the splitter-combiner of the second MM-VOA, and (iii) the output of the combiner-splitter of the second MM-VOA is coupled with the input of the combiner-splitter of the first MM-VOA. In addition, the first MM-VOA and the second MM-VOA are arranged in a loopback configuration so that the phase shifter is arranged to selectively cause a signal traveling through the first multimode waveguide of the first MM-VOA to undergo a phase shift simultaneously with causing a signal traveling through the first multimode waveguide of the second MM-VOA to undergo a phase shift.

### Example Embodiments

Disclosed herein are various multimode topologies of optical switches and apparatuses that include such optical switches. In at least one example, the optical switches disclosed herein can advantageously enable multiple independent signals to be dynamically turned on, turned off, or otherwise attenuated with one multimode phase shifter, e.g., a single heater, rather than each signal being attenuated by a dedicated phase shifter. In this way, electrical power can be supplied to only one phase shifter to enable control of multiple signals, and the electrical circuitry, drivers, etc. for the optical switch can be reduced compared to some optical switches. Moreover, the architecture of the optical switches disclosed herein can facilitate the use of materials (e.g., silicon nitride) with relatively low random phase noise (RPN) for the platform of the optical switch. Such platform materials can enable the construction of a “normally on” or “normally off” optical switch.

In one or more other examples, an optical switch disclosed herein can include a plurality of multimode variable optical attenuators (MM-VOAs) that can be arranged so that one multimode phase shifter can be used to control more than two signals, such as four signals. In another example, an optical switch disclosed herein can be arranged so that a multimode phase shifter can be used to control at least three signals that can be output each with different optical modes. In a further example, an optical switch disclosed herein can include MM-VOAs arranged in a loopback configuration so that a phase shifter can be arranged to selectively cause optical signals traveling through multimode waveguides of respective ones of the MM-VOAs to simultaneously undergo a phase shift. In other examples, the optical switches disclosed herein can be implemented in various apparatuses, such as optical transceivers.

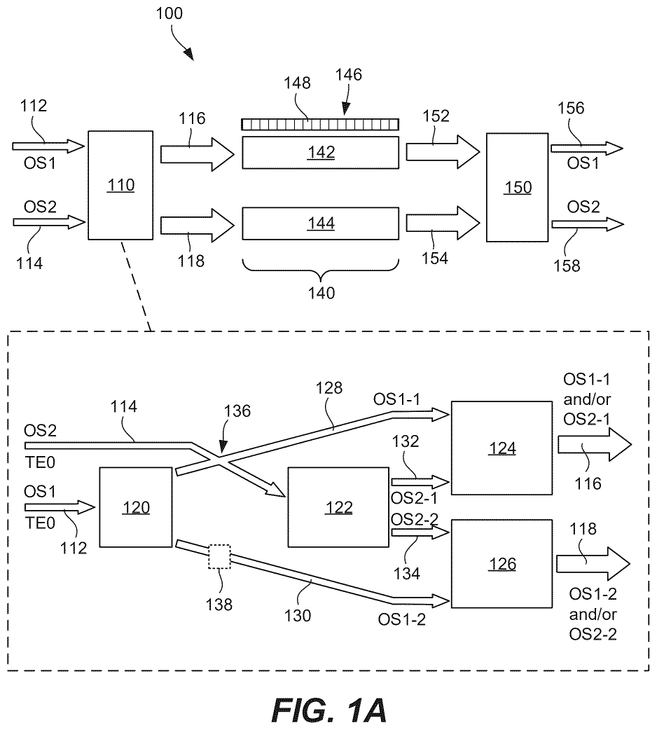

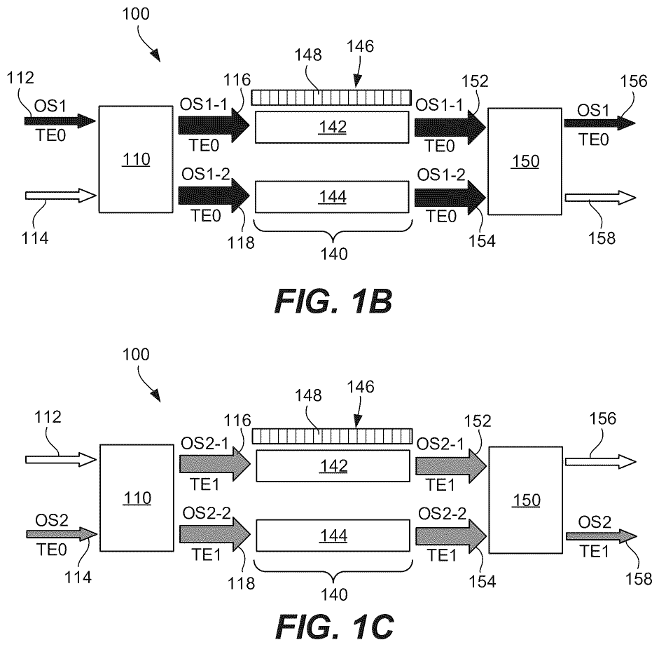

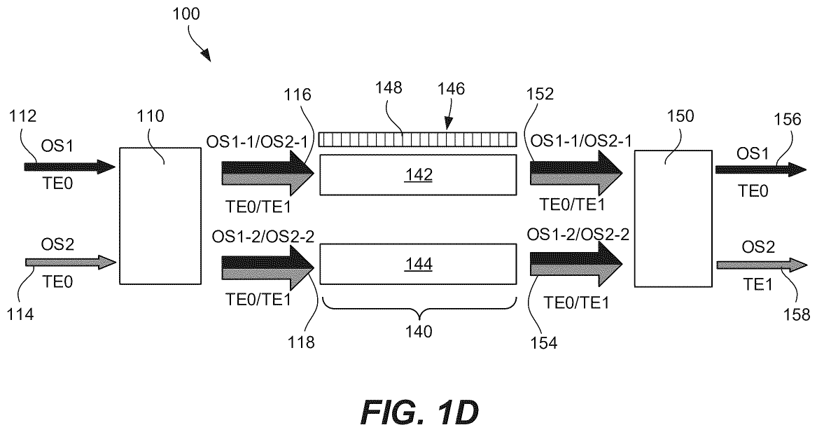

Turning now to the drawings, FIG. 1A depicts a schematic block diagram of an optical switch 100 according to one or more aspects of the present disclosure. In one or more examples, the optical switch 100 can be a multimode variable optical attenuator (MM-VOA), or multimode Mach-Zehnder interferometer (MZI). The optical switch 100 can be a normally-open switch or a normally-closed switch, for example, and can be implemented in a number of applications, such as in an optical transceiver loopback (e.g., one for each transmitter modulator), and/or, on a receiver side of an optical transceiver, such as prior to a photodiode along an optical path so as to limit trans-impedance amplifier (TIA) power.

As shown in FIG. 1A, the optical switch 100 can include an input splitter 110, a phase shift section 140, and an output combiner 150. In one or more examples, these optical components can be arranged in a silicon nitride (SiN) layer. In one or more other examples, the optical components can be arranged in a layer formed of one or more other materials. The input splitter 110 can be arranged to split optical signals into portions that can travel along separate optical paths or arms of the optical switch 100. In addition, depending on the input port of the input splitter 110 into which an optical signal is launched, the input splitter 110 can change a mode of the optical signal, e.g., from TE0 to TE1, or from a lowest order of transverse electric (TE) mode to a second lowest order of TE mode. The phase shift section 140 can include a phase shifter 146 that can be controlled to selectively change a phase of an optical signal, or a portion thereof, traveling through one of the arms, e.g., so that the portions in the separate arms are either in phase at zero degrees (0°), e.g., so that the optical switch 100 is in an “on” state to allow optical signals through the optical switch 100, or out of phase by one hundred eighty degrees (180°), e.g., so that the optical switch 100 is in an “off” state to prevent optical signals from passing through the optical switch 100. The output combiner 150 can combine the portions of the optical signals traveling along the separate arms and can output them by way of output ports according to their optical modes. The input splitter 110, the phase shift section 140, and the output combiner 150 will be further described below.

The input splitter 110 can include single mode inputs (or SM inputs), including a first SM input 112 and a second SM input 114. The first and second SM inputs 112, 114 can each be arranged to support a single optical mode at a time, such as TE0. For instance, the first SM input 112 can be arranged to support a first optical mode (e.g., TE0) and the second SM input 114 can also be arranged to support the first optical mode (e.g., TE0). In addition, the input splitter 110 can include multimode outputs (or MM outputs), including a first MM output 116 and a second MM output 118. The first and second MM outputs 116, 118 can each be arranged to support multiple optical modes at a time, such as TE0 and TE1.

As shown in the close-up section in FIG. 1A, a schematic block diagram of one example arrangement of the input splitter 110 of the optical switch 100 is provided. In one or more examples, the input splitter 110 can include a first Y-splitter 120, a second Y-splitter 122, a first modemux 124, and a second modemux 126.

The first Y-splitter 120 is coupled with the first SM input 112 and has first and second splitter outputs 128, 130. The first Y-splitter 120 is arranged to split optical signals, such as a first optical signal OS1, launched into the first SM input 112, e.g., 50/50, into a first portion OS1-1 and a second portion OS1-2. The first portion OS1-1 is output along the first splitter output 128 while the second portion OS1-2 is output along the second splitter output 130. The first and second splitter outputs 128, 130 can be SM outputs. The second Y-splitter 122 is coupled with the second SM input 114 and has first and second splitter outputs 132, 134. The second Y-splitter 122 is arranged to split optical signals, such as a second optical signal OS2, launched into the second SM input 114, e.g., 50/50, into a first portion OS2-1 and a second portion OS2-2. The first portion OS2-1 is output along the first splitter output 132 while the second portion OS2-2 is output along the second splitter output 134. The first and second splitter outputs 132, 134 can be SM outputs.

The first modemux 124 of the input splitter 110 is coupled with the first splitter output 128 of the first Y-splitter 120 and the first splitter output 132 of the second Y-splitter 122. The first modemux 124 can provide the first MM output 116 of the input splitter 110. When the first optical signal OS1 and the second optical signal OS2 are launched into their respective inlet ports, the first modemux 124 can “mux” or combine the first portion OS1-1 of the first optical signal OS1 and the first portion OS2-1 of the second optical signal OS2 onto the first MM output 116. In one or more examples, in combing the first portion OS1-1 of the first optical signal OS1 and the first portion OS2-1 of the second optical signal OS2 onto the first MM output 116, the first modemux 124 can change the optical mode of the first portion OS2-1 of the second optical signal OS2, e.g., from TE0 to TE1, while keeping the optical mode of the first portion OS1-1 of the first optical signal OS1 the same, e.g., TE0. In this regard, the first MM output 116 can carry two optical modes.

The second modemux 126 is coupled with the second splitter output 130 of the first Y-splitter 120 and the second splitter output 134 of the second Y-splitter 122. The second modemux 126 can provide the second MM output 118 of the input splitter 110. When the first optical signal OS1 and the second optical signal OS2 are launched into their respective inlet ports, the second modemux 126 can “mux” or combine the second portion OS1-2 of the first optical signal OS1 and the second portion OS2-2 of the second optical signal OS2 onto the second MM output 118. In one or more examples, in combing the second portion OS1-2 of the first optical signal OS1 and the second portion OS2-2 of the second optical signal OS2 onto the second MM output 118, the second modemux 126 can change the optical mode of the second portion OS2-2 of the second optical signal OS2, e.g., from TE0 to TE1, while keeping the optical mode of the second portion OS1-2 of the first optical signal OS1 the same, e.g., TE0. In this regard, the second MM output 118 can carry two optical modes.

In at least one example, the second SM input 114 can cross the first splitter output 128 of the first Y-splitter 120, e.g., at an optical crossing 136 as shown in FIG. 1A. In one or more examples, the second splitter output 130 of the first Y-splitter 120 can include a pseudo optical crossing 138 that mimics the optical losses associated with the optical crossing 136. Accordingly, with the pseudo optical crossing 138, the optical power downstream of the optical crossing 136 along the first splitter output 128 of the first Y-splitter 120 and the optical power downstream of the pseudo optical crossing 138 along the second splitter output 130 of the first Y-splitter 120 can be equal or substantially equal, which can ensure the first and second modemuxes 124, 126 receive the first and second portions OS1-1, OS1-2 having substantially the same optical power. In at least one example, the pseudo optical crossing 138 can be a passive device or layer arranged in the optical path that can be tuned to create a degree of optical loss that mimics optical losses associated with the optical crossing 136. In at least one other example, the second SM input 114 can cross the second splitter output 130 of the first Y-splitter 120.

The phase shift section 140 can include a first multimode waveguide (or first MM WG 142), a second multimode waveguide (or second MM WG 144), and a phase shifter 146. The first MM WG 142 can be coupled with the first MM output 116 of the input splitter 110. The second MM WG 144 can be coupled with the second MM output 118 of the input splitter 110. The first and second MM WGs 142, 144 can each be arranged to support multiple optical modes at a time, such as TE0 and TE1. The phase shifter 146 can be arranged to selectively cause an optical signal, or a portion thereof, traveling through the first MM WG 142 to undergo a phase shift. In one or more examples, the phase shifter 146 can be a thermal phase shifter having a heater 148. The heater 148 can be an electrical resistance heater, for example. In such examples, electrical current can be provided to the heater 148, causing the heater 148 to heat the first MM WG 142 and the optical signal or signals traveling therethrough, which can cause the optical signals to undergo a phase shift. The heater 148 can be selectively tuned so that the applied heat causes the optical signal or signals within the first MM WG 142 to be out of phase with respect to the optical signal or signals within the second MM WG 144, e.g., by one hundred eighty degrees (180°). In one or more other examples, the phase shifter 146 can be a different type of phase shifter.

In the example of FIG. 1A, the phase shifter 146 is arranged on an exterior side of the first MM WG 142, and is arranged to selectively cause an optical signal, or a portion thereof, traveling through the first MM WG 142 to undergo a phase shift. In other examples, the phase shifter 146 can be arranged on an exterior side of the second MM WG 144, and can be arranged to selectively cause an optical signal, or a portion thereof, traveling through the second MM WG 144 to undergo a phase shift. In yet further examples, the phase shifter 146 can be arranged between the first MM WG 142 and the second MM WG 144 (i.e., on an interior side of the respective first and second MM WGs 142, 144), and can be arranged to selectively cause an optical signal, or a portion thereof, traveling through the first MM WG 142 to undergo a phase shift or an optical signal, or a portion thereof, traveling through the second MM WG 144 to undergo a phase shift. In one or more further examples, the phase shifter 146 can be a first phase shifter arranged on an exterior side of the first MM WG 142 and the phase shift section 140 can include a second phase shifter arranged on an exterior side of the second MM WG 144. In such examples, the first phase shifter or the second phase shifter can be selectively activated so as to cause a phase shift to an optical signal, or portions thereof, traveling through its associated MM WG.

The output combiner 150 can include multimode inputs, including a first MM input 152 and a second MM input 154 coupled with the first MM WG 142 and the second MM WG 144, respectively. The first and second MM inputs 152, 154 can each be arranged to support multiple optical modes at a time, such as TE0 and TE1. In addition, the output combiner 150 can include single mode outputs, including a first SM output 156 and a second SM output 158. The first and second SM outputs 156, 158 can each be arranged to support a single optical mode at a time. For instance, the first SM output 156 can be arranged to support a first optical mode (e.g., TE0) and the second SM output 158 can be arranged to support a second optical mode (e.g., TE1). The output combiner 150 can mirror the input splitter 110 in one or more examples, except that the noted signals are combined rather than split and the higher order modes can be become lost, resulting in SM optical signals at the first and second SM outputs 156, 158.

Example manners in which the optical switch 100 can be operated will now be described. In a first example, as shown in FIG. 1B, a first optical signal OS1 having a first optical mode (e.g., TE0 in this example) can be launched into the first SM input 112 of the input splitter 110. In this example, no optical signals are launched into the second SM input 114 of the input splitter 110. The input splitter 110 can split the first optical signal OS1 into a first portion OS1-1 and a second portion OS1-2 according to a predefined ratio (e.g., 50/50). The first portion OS1-1 can be output from the input splitter 110 by way of the first MM output 116 and the second portion OS1-2 can be output from the input splitter 110 by way of the second MM output 118. The first portion OS1-1 and the second portion OS1-2 can be split by the input splitter 110 but yet keep the first optical mode.

The first portion OS1-1 travels along the first MM WG 142 while the second portion OS1-2 travels along the second MM WG 144. As noted above, the optical switch 100 can be NOS, and consequently, the phase shifter 146 can be set in a normally off state. In this manner, the first portion OS1-1 and the second portion OS1-2 can travel respectively through the first MM WG 142 and the second MM WG 144 in phase, or rather, at zero degrees (0°) with respect to one another. Accordingly, the first portion OS1-1 and the second portion OS1-2 can respectively exit the first MM WG 142 and the second MM WG 144 and can enter the output combiner 150 by way of the first MM input 152 and the second MM input 154, respectively. The output combiner 150 can combine the first portion OS1-1 and the second portion OS1-2, which both have the first optical mode TE0, onto the first SM output 156. In this regard, the first optical signal OS1 launched into the first SM input 112 can pass through the optical switch 100 and can be output by way of the first SM output 156 with minimal optical loss. In this way, the optical switch 100 is in an “on” state.

To turn the switch or optical switch 100 to an “off” state, the phase shifter 146 can be controlled, e.g., to provide a thermal application, so that the first portion OS1-1 traveling through the first MM WG 142 is phase shifted, e.g., to be one hundred degrees (180°) out of phase with respect to the second portion OS1-2 traveling through the second MM WG 144. Accordingly, at the output combiner 150, the first portion OS1-1 and the second portion OS1-2 effectively cancel each other out, resulting in no light output by the optical switch 100. In this manner, this first channel of the optical switch 100 can be selectively switched off.

In a second example, as shown in FIG. 1C, a second optical signal OS2 having a first mode (e.g., TE0 in this example) can be launched into the second SM input 114 of the input splitter 110. In this second example, no optical signals are launched into the first SM input 112 of the input splitter 110. The input splitter 110 can split the second optical signal OS into a first portion OS2-1 and a second portion OS2-2 according to a predefined ratio (e.g., 50/50). As noted above, the input splitter 110 can be arranged to change the mode of the first and second portions OS2-1, OS2-2 from the first mode to a second mode, e.g., from TE0 to TE1. The first portion OS2-1 having the second mode can be output from the input splitter 110 by way of the first MM output 116 and the second portion OS2-2 having the second mode can be output from the input splitter 110 by way of the second MM output 118.

The first portion OS2-1 travels along the first MM WG 142 while the second portion OS2-2 travels along the second MM WG 144. As noted above, the optical switch 100 can be NOS, and thus, the phase shifter 146 can be set in a normally off state. In this manner, the first portion OS2-1 and the second portion OS2-2 can travel respectively through the first MM WG 142 and the second MM WG 144 in phase, or rather, at zero degrees (0°) with respect to one another. Accordingly, the first portion OS2-1 and the second portion OS2-2 can respectively exit the first MM WG 142 and the second MM WG 144 and can enter the output combiner 150 by way of the first MM input 152 and the second MM input 154, respectively. The output combiner 150 can combine the first portion OS2-1 and the second portion OS2-2, which both have the second optical mode TE1, onto the second SM output 158. In this regard, the first optical signal OS2 launched into the second SM input 114 can pass through the optical switch 100 and can be output by way of the second SM output 158 with minimal optical loss. In this way, the optical switch 100 is in an “on” state.

To turn the switch or optical switch 100 to an “off” state, the phase shifter 146 can be controlled, e.g., to provide a thermal application, so that the first portion OS2-1 traveling through the first MM WG 142 is phase shifted, e.g., to be one hundred degrees (180°) out of phase with respect to the second portion OS2-2 traveling through the second MM WG 144. Accordingly, at the output combiner 150, the first portion OS2-1 and the second portion OS2-2 effectively cancel each other out, resulting in no light output by the optical switch 100. In this manner, this second channel of the optical switch 100 can be selectively switched off.

In a third example, as shown in FIG. 1D, the first optical signal having a first mode (e.g., TE0 in this example) and the second optical signal OS2 having the first mode (e.g., TE0) can be launched simultaneously into the first SM input 112 and the second SM input 114, respectively. The first optical signal OS1 having the first mode can be split into a first portion OS1-1 and a second portion OS1-2 according to a predefined ratio (e.g., 50/50), and likewise, the second optical signal OS2 having the first mode can be split into a first portion OS2-1 and a second portion OS2-2 according to a predefined ratio (e.g., 50/50). The first portion OS1-1 of the first optical signal OS1 can be output from the input splitter 110 by way of the first MM output 116 and the second portion OS1-2 of the first optical signal OS1 can be output from the input splitter 110 by way of the second MM output 118. The first and second portions OS1-1, OS1-2 can be output having the first mode (e.g., TE0). The input splitter 110 can be arranged to change the mode of the first and second portions OS2-1, OS2-2 from the first mode (e.g., TE0) to a second mode (e.g., TE1). The first portion OS2-1 having the second mode can be output from the input splitter 110 by way of the first MM output 116 and the second portion OS2-2 having the second mode can be output from the input splitter 110 by way of the second MM output 118.

The first portions OS1-1, OS2-1 travel along the first MM WG 142 while the second portions OS1-2, OS2-2 travel along the second MM WG 144. As noted above, the optical switch 100 can be NOS, and therefore, the phase shifter 146 can be set in a normally off state. In this manner, the first portion OS1-1 and the second portion OS1-2 can travel respectively through the first MM WG 142 and the second MM WG 144 in phase, or rather, at zero degrees (0°) with respect to one another. Similarly, the first portion OS2-1 and the second portion OS2-2 can travel respectively through the first MM WG 142 and the second MM WG 144 in phase, or rather, at zero degrees (0°) with respect to one another. The first portions OS1-1, OS2-1 and the second portions OS1-2, OS2-2 can respectively exit the first MM WG 142 and the second MM WG 144 and can enter the output combiner 150 by way of the first MM input 152 and the second MM input 154, respectively.

The output combiner 150 can combine the first portion OS1-1 and the second portion OS1-2, which both have the first optical mode TE0, onto the first SM output 156, and in addition, can combine the first portion OS2-1 and the second portion OS2-2, which both have the second optical mode TE1, onto the second SM output 158. In this regard, the first optical signal OS1 launched into the first SM input 112 can pass through the optical switch 100 and can be output by way of the first SM output 156 with minimal optical loss, and similarly, the second optical signal OS2 launched into the second SM input 114 can pass through the optical switch 100 and can be output by way of the second SM output 158 with minimal optical loss. In this way, the optical switch 100 is in an “on” state.

To turn the optical switch 100 to an “off” state, the phase shifter 146 can be controlled, e.g., to provide a thermal application, so that i) the first portion OS1-1 traveling through the first MM WG 142 is phase shifted, e.g., to be one hundred degrees (180°) out of phase with respect to the second portion OS1-2 traveling through the second MM WG 144, and ii) so the first portion OS2-1 traveling through the first MM WG 142 is phase shifted, e.g., to be one hundred degrees (180°) out of phase with respect to the second portion OS2-2 traveling through the second MM WG 144. Accordingly, at the output combiner 150, the first portion OS1-1 and the second portion OS1-2 effectively cancel each other out and the first portion OS2-1 and the second portion OS2-2 effectively cancel each other out, resulting in no light output by the optical switch 100. In this manner, the first and second channels of the optical switch 100 can be selectively switched off.

The optical switch 100 can provide certain advantages, benefits, and/or technical effects. For instance, the architecture of the optical switch 100 can enable two signal channels to be turned “on” or turned “off” with only one phase shifter, e.g., a single heater, rather than the signal channels each having a dedicated phase shifter. Accordingly, electrical power can be supplied to only one phase shifter to enable control of two signals. This can reduce the electrical power draw to control the optical switch 100 and/or the apparatus in which the optical switch 100 is implemented. Moreover, electrical circuitry components, drivers, etc. can be reduced compared to some optical switches. In addition, the architecture of the optical switch 100 can facilitate the use of materials with relatively low random phase noise (RPN), such as silicon nitride for the platform of the optical switch 100.

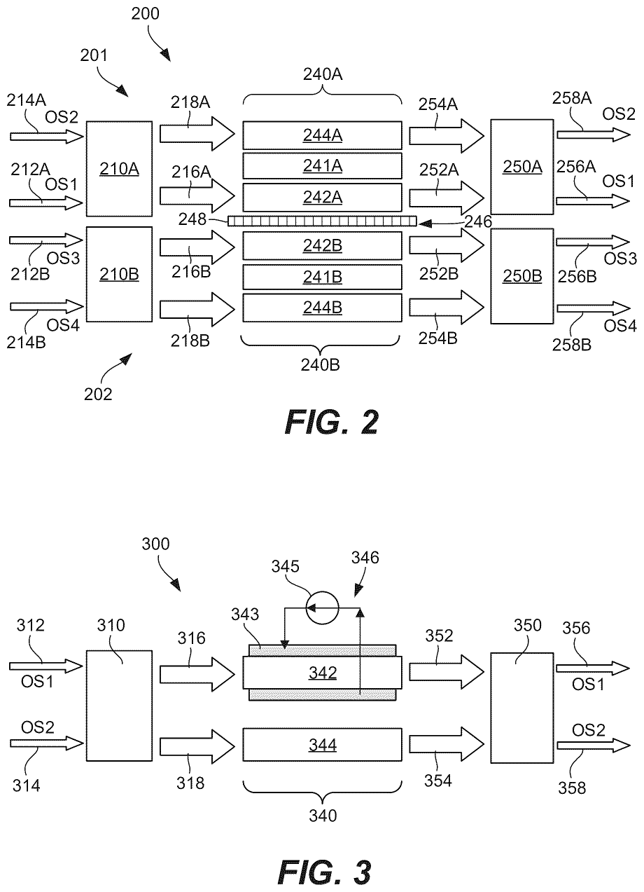

FIG. 2 depicts a schematic block diagram of an optical switch 200 according to one or more aspects of the present disclosure. The optical switch 200 includes a first multimode (MM) VOA, or first MM-VOA 201, and a second MM-VOA 202. The first MM-VOA 201 is configured in a similar manner as the optical switch 100 and the second MM-VOA 202 is likewise configured in a similar manner as the optical switch 100 of FIG. 1.

The first MM-VOA 201 can include an input splitter 210A, a phase shift section 240A, and an output combiner 250A. In one or more examples, these optical components can be arranged in a SiN layer. The input splitter 210A can include SM inputs, including a first SM input 212A and a second SM input 214A. In addition, the input splitter 210A can include MM outputs, including a first MM output 216A and a second MM output 218A. The phase shift section 240A can include a first MM WG 242A and a second MM WG 244A. In at least one example, a cladding 241A (e.g., an oxide etch) can be arranged between the first MM WG 242A and the second MM WG 244A so as to create an air gap therebetween, which can further increase efficiency. The output combiner 250A can include MM inputs, including a first MM input 252A and a second MM input 254A coupled with the first MM WG 242A and the second MM WG 244A, respectively. Further, the output combiner 250A can include SM outputs, including a first SM output 256A and a second SM output 258A.

The second MM-VOA 202 can include an input splitter 210B, a phase shift section 240B, and an output combiner 250B. In one or more examples, these optical components can be arranged in a SiN layer. The input splitter 210B can include SM inputs, including a first SM input 212B and a second SM input 214B. In addition, the input splitter 210B can include MM outputs, including a first MM output 216B and a second MM output 218B. The phase shift section 240B can include a first MM WG 242B and a second MM WG 244B. In at least one example, a cladding 241B (e.g., an oxide etch) can be arranged between the first MM WG 242A and the second MM WG 244A so as to create an air gap therebetween, which can further increase efficiency. The output combiner 250B can include MM inputs, including a first MM input 252B and a second MM input 254B coupled with the first MM WG 242B and the second MM WG 244B, respectively. Further, the output combiner 250B can include SM outputs, including a first SM output 256B and a second SM output 258B.

In one or more examples, a first optical signal OS1 can be launched into the first SM input 212A, a second optical signal OS2 can be launched into the second SM input 214A, a third optical signal OS3 can be launched into the first SM input 212B, and a fourth optical signal OS4 can be launched into the second SM input 214B. These optical signals can travel along respective optical paths. For instance, the first and second optical signals OS1, OS2 can travel through the first MM-VOA 201 in a similar manner described above with respect to the first and second optical signals OS1, OS2 traveling through the optical switch 100 in FIG. 1D. Similarly, the third and fourth optical signals OS3, OS4 can travel through the second MM-VOA 202 in a similar manner described above with respect to the first and second optical signals OS1, OS2 traveling through the optical switch 100 in FIG. 1D.

For the depicted example of FIG. 2, the first MM-VOA 201 and the second MM-VOA are arranged so that a phase shifter 246 (or heater 248 in this example) is shared between the first MM-VOA 201 and the second MM-VOA 202. Stated another way, the heater 248 can be arranged to heat two MM WGs at the same time. In this regard, the phase shifter 246, or heater 248 in this example, can be selectively controlled to cause a phase shift in the first optical signal OS1 traveling through the first MM WG 242A of the first MM-VOA 201 and the third optical signal OS3 traveling through the first MM WG 242B of the second MM-VOA 202.

To turn “on” the first, second, third, and fourth optical signals OS1, OS2, OS3, OS4, the heater 248 can be controlled to an “off” state so that there is no heat application to the first MM WGs 242A, 242B. This allows the first, second, third, and fourth optical signals OS1, OS2, OS3, OS4 to be at zero degrees (0°) with respect to one another, or rather, with no phase shift therebetween. Accordingly, the first, second, third, and fourth optical signals OS1, OS2, OS3, OS4 all pass through the optical switch 200 with minimal optical loss. To turn “off” the first, second, third, and fourth optical signals OS1, OS2, OS3, OS4, the heater 248 can be controlled to an “on” state so that heat is applied to the first MM WGs 242A, 242B. Accordingly, the first optical signal OS1 can be controlled to be one hundred eighty degrees (180°) out of phase with respect to the second optical signal OS2, which can effectively cancel these signals out at the output combiner 250A. In addition, the third optical signal OS1 can be controlled to be one hundred eighty degrees (180°) out of phase with respect to the fourth optical signal OS4, which can effectively cancel these signals out at the output combiner 250B. Advantageously, the architecture of the optical switch 200 can enable four signal channels to be turned “on” or turned “off” with only one phase shifter, e.g., a single heater. In addition, the architecture of the optical switch 200 can facilitate the use of materials with relatively low RPN, such as silicon nitride for the platform of the optical switch 200. However, the silicon platforms are also applicable.

FIG. 3 depicts a schematic block diagram of an optical switch 300 according to one or more aspects of the present disclosure. The optical switch 300 is configured in a similar manner as the optical switch 100, except as otherwise provided below.

The optical switch 300 can include an input splitter 310, a phase shift section 340, and an output combiner 350. In one or more examples, these optical components can be arranged in a silicon layer. The input splitter 310 can include SM inputs, including a first SM input 312 and a second SM input 314. In addition, the input splitter 310 can include MM outputs, including a first MM output 316 and a second MM output 318. The phase shift section 340 can include a first MM WG 342, a second MM WG 344, and a phase shifter 346. The output combiner 350 can include MM inputs, including a first MM input 352 and a second MM input 354 coupled with the first MM WG 342 and the second MM WG 344, respectively. Further, the output combiner 350 can include SM outputs, including a first SM output 356 and a second SM output 358. In one or more examples, a first optical signal OS1 can be launched into the first SM input 312 and a second optical signal OS2 can be launched into the second SM input 314, e.g., at the same time or at different times.

In the depicted example of FIG. 3, the phase shifter 346 is an electro-optic phase shifter. As illustrated, the phase shifter 346, or electro-optic phase shifter in this example, includes an electrically-conductive jacket 343 that surrounds or circumscribes the first MM WG 342. The electrically-conductive jacket 343 can be formed of doped silicon, for example. The phase shifter 346 can also include an electrical power supply 345, such as a current source. The electrical power supply 345 can be electrically coupled with the electrically-conductive jacket 343. In operation, the electrical power supply 345 can be controlled to provide electrical power to the electrically-conductive jacket 343. The electric current flowing through the electrically-conductive jacket 343 can cause a first portion of an optical signal traveling through the first MM WG 342 to be phase shifted, such as one hundred eighty degrees (180°) out of phase with a second portion of the optical signal traveling through the second MM WG 344. In this way, at the output combiner 350, these two portions can cancel each other out, effectively turning the optical switch 300 to an “off” state.

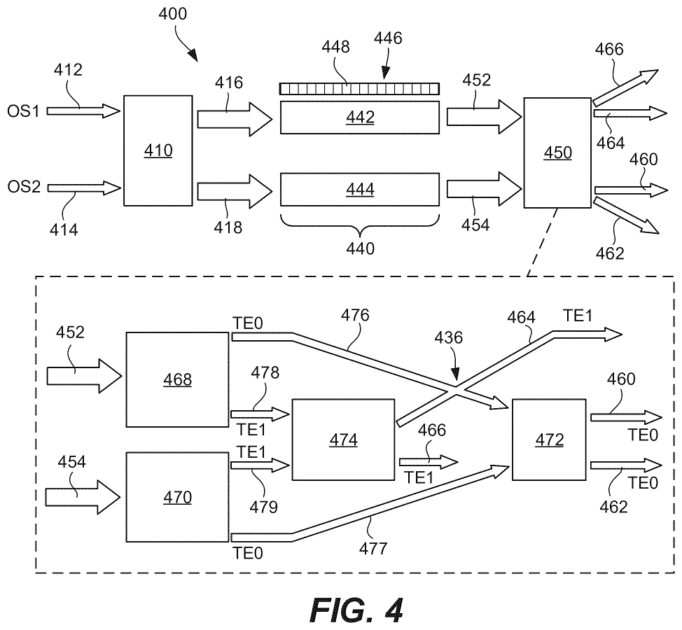

FIG. 4 depicts a schematic block diagram of an optical switch 400 according to one or more aspects of the present disclosure. The optical switch 400 is configured in a similar manner as the optical switch 100, except as otherwise provided below.

The optical switch 400 can include an input splitter 410, a phase shift section 440, and an output combiner 450. In one or more examples, these optical components can be arranged in a silicon nitride layer. The input splitter 410 can include SM inputs, including a first SM input 412 and a second SM input 414. In addition, the input splitter 410 can include MM outputs, including a first MM output 416 and a second MM output 418. The phase shift section 440 can include a first MM WG 442, a second MM WG 444, and a phase shifter 446. The phase shifter 446 can be a heater 448, for example. The output combiner 450 can include MM inputs, including a first MM input 452 and a second MM input 454 coupled with the first MM WG 442 and the second MM WG 444, respectively. Further, the output combiner 450 can include SM outputs, including a first mode thru output 460, a first mode cross output 462, a second mode thru output 464, and a second mode cross output 466. In one or more examples, a first optical signal OS1 can be launched into the first SM input 412 and a second optical signal OS2 can be launched into the second SM input 414, e.g., at the same time or at different times.

In the depicted example of FIG. 4, the output combiner 450 can include first modemux 468, a second modemux 470, a first coupler 472, and a second coupler 474. The first modemux 468 can be coupled with the first MM WG 442 by way of the first MM input 452. The first modemux 468 can have first and second modemux outputs 476, 478. The first modemux 468 can “demux” or distribute an optical signal (or portions of multiple optical signals) carried by the first MM input 452 into the first and second modemux outputs 476, 478. For instance, a portion of an optical signal having a first mode (TE0 in this example) can be output to the first modemux output 476 while a portion of an optical signal having a second mode (TE1 in this example) can be output to the second modemux output 478.

The second modemux 470 can be coupled with the second MM WG 444 by way of the second MM input 454. The second modemux 470 can have first and second modemux outputs 477, 479. The second modemux 470 can “demux” or distribute an optical signal (or portions of multiple optical signals) carried by the second MM input 454 into the first and second modemux outputs 477, 479. For instance, a portion of an optical signal having a first mode (TE0 in this example) can be output to the first modemux output 477 while a portion of an optical signal having a second mode (TE1 in this example) can be output to the second modemux output 479.

In at least one example, the first modemux output 476 can cross the second mode thru output 464, e.g., at an optical crossing 436 as shown in FIG. 4. In one or more examples, the first modemux output 477 can include a pseudo optical crossing that mimics the optical losses associated with the optical crossing 436.

The first coupler 472 can be coupled with the first modemux output 476 of the first modemux 468 and the first modemux output 477 of the second modemux 470. The first coupler 472 can have first mode outputs, including the first mode thru output 460 and the first mode cross output 462. In the example of FIG. 4, the first coupler 472 can be a 2×2 adiabatic coupler. Accordingly, when the optical switch 400 is in an “on” state, all the light exiting the first coupler 472 can be output by the first mode cross output 462 and none of the light comes out of the first mode thru output 460. In contrast, when the optical switch 400 is in an “off” state, all the light exiting the first coupler 472 can be output by the first mode thru output 460 and none of the light comes out of the first mode cross output 462. Accordingly, the optical signals having the first mode can be kept in a waveguide (e.g., the first mode thru output 460 or the first mode cross output 462) regardless of whether the optical switch 400 is “on” or “off”.

The second coupler 474 can be coupled with the second modemux output 478 of the first modemux 468 and the second modemux output 479 of the second modemux 470. The second coupler 474 can have second mode outputs, including the second mode thru output 464 and the second mode cross output 466. In the example of FIG. 4, the second coupler 474 can be a 2×2 adiabatic coupler. Accordingly, when the optical switch 400 is in an “on” state, all the light exiting the second coupler 474 can be output by the second mode cross output 466 and none of the light comes out of the second mode thru output 464. In contrast, when the optical switch 400 is in an “off” state, all the light exiting the second coupler 474 can be output by the second mode thru output 464 and none of the light comes out of the second mode cross output 466. Accordingly, the optical signals having the second mode can be kept in a waveguide (e.g., the second mode thru output 464 or the second mode cross output 466) regardless of whether the optical switch 400 is “on” or “off”.

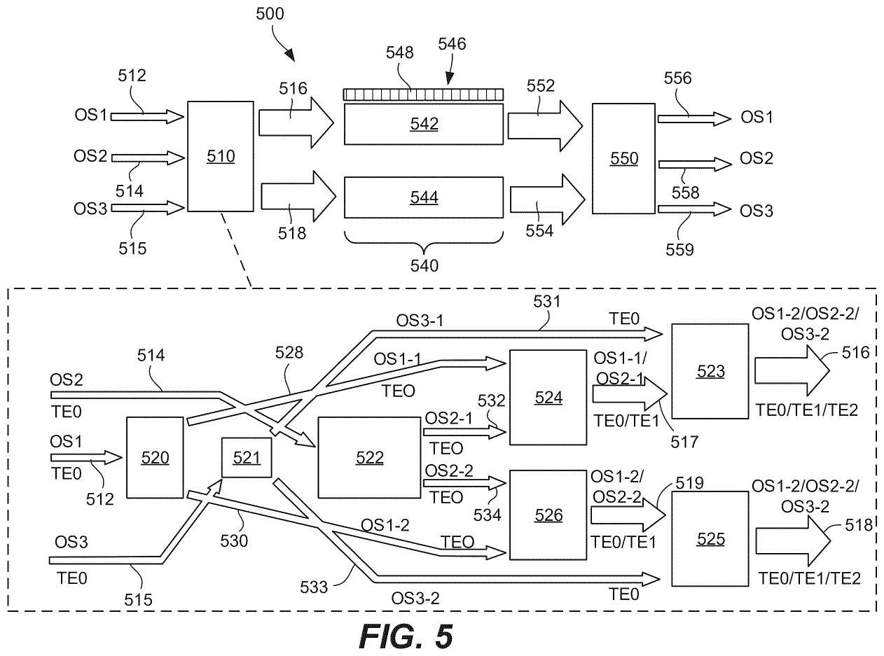

FIG. 5 depicts a schematic block diagram of an optical switch 500 according to one or more aspects of the present disclosure. The optical switch 500 is configured in a similar manner as the optical switch 100, except as otherwise provided below.

The optical switch 500 can include an input splitter 510, a phase shift section 540, and an output combiner 550. In one or more examples, these optical components can be arranged in a silicon layer. The input splitter 510 can include SM inputs, including a first SM input 512, a second SM input 514, and a third SM input 515. In addition, the input splitter 510 can include MM outputs, including a first MM output 516 and a second MM output 518. The phase shift section 540 can include a first MM WG 542, a second MM WG 544, and a phase shifter 546. The phase shifter 546 can be a thermal phase shifter having a heater 548, for example. The output combiner 550 can include MM inputs, including a first MM input 552 and a second MM input 554 coupled with the first MM WG 542 and the second MM WG 544, respectively. Further, the output combiner 550 can include SM outputs, including a first SM output 556, a second SM output 558, and a third SM output 559. In one or more examples, a first optical signal OS1 can be launched into the first SM input 512, a second optical signal OS2 can be launched into the second SM input 514, and a third optical signal OS3 can be launched into the third SM input 515, e.g., at the same time or at different times.

In the close-up section of FIG. 5, a schematic block diagram of one example arrangement of the input splitter 510 is depicted. In one or more examples, the input splitter 510 can include a first Y-splitter 520, a second Y-splitter 522, a third Y-splitter 521, a first modemux stage, and a second modemux stage. The first modemux stage can include a first modemux 524 and a second modemux 526. The second modemux stage can include a third modemux 523 and a fourth modemux 525.

The first Y-splitter 520 is coupled with the first SM input 512 and has first and second splitter outputs 528, 530. The first Y-splitter 520 is arranged to split optical signals, such as the first optical signal OS1, launched into the first SM input 512, e.g., 50/50, into a first portion OS1-1 and a second portion OS1-2. The first portion OS1-1 is output along the first splitter output 528 while the second portion OS1-2 is output along the second splitter output 530. The first and second splitter outputs 528, 530 can be SM outputs arranged to support a single optical mode, such as TE0.

The second Y-splitter 522 is coupled with the second SM input 514 and has first and second splitter outputs 532, 534. The second Y-splitter 522 is arranged to split optical signals, such as the second optical signal OS2, launched into the second SM input 514, e.g., 50/50, into a first portion OS2-1 and a second portion OS2-2. The first portion OS2-1 is output along the first splitter output 532 while the second portion OS2-2 is output along the second splitter output 534. The first and second splitter outputs 532, 534 can be SM outputs arranged to support a single optical mode, such as TE0.

The third Y-splitter 521 is coupled with the third SM input 515 and has first and second splitter outputs 531, 533. The third Y-splitter 521 is arranged to split optical signals, such as the third optical signal OS3, launched into the third SM input 515, e.g., 50/50, into a first portion OS3-1 and a second portion OS3-2. The first portion OS3-1 is output along the first splitter output 531 while the second portion OS3-2 is output along the second splitter output 533. The first and second splitter outputs 531, 533 can be SM outputs arranged to support a single optical mode, such as TE0.

The first modemux 524 of the first modemux stage is coupled with the first splitter output 528 of the first Y-splitter 520 and the first splitter output 532 of the second Y-splitter 522. The first modemux 524 can include a first MM output 517. When the first optical signal OS1 and the second optical signal OS2 are launched into their respective inlet ports, the first modemux 524 can “mux” or combine the first portion OS1-1 of the first optical signal OS1 and the first portion OS2-1 of the second optical signal OS2 onto the first MM output 517. In one or more examples, in combing the first portion OS1-1 of the first optical signal OS1 and the first portion OS2-1 of the second optical signal OS2 onto the first MM output 517, the first modemux 524 can change the optical mode of the first portion OS2-1 of the second optical signal OS2, e.g., from TE0 to TE1, while keeping the optical mode of the first portion OS1-1 of the first optical signal OS1 the same, e.g., TE0. In this regard, the first MM output 517 can carry two optical modes.

The second modemux 526 of the first modemux stage is coupled with the second splitter output 530 of the first Y-splitter 520 and the second splitter output 534 of the second Y-splitter 522. The second modemux 526 can include a second MM output 519. When the first optical signal OS1 and the second optical signal OS2 are launched into their respective inlet ports, the second modemux 526 can “mux” or combine the second portion OS1-2 of the first optical signal OS1 and the second portion OS2-2 of the second optical signal OS2 onto the second MM output 519. In one or more examples, in combing the second portion OS1-2 of the first optical signal OS1 and the second portion OS2-2 of the second optical signal OS2 onto the second MM output 519, the second modemux 526 can change the optical mode of the second portion OS2-2 of the second optical signal OS2, e.g., from TE0 to TE1, while keeping the optical mode of the second portion OS1-2 of the first optical signal OS1 the same, e.g., TE0. In this regard, the second MM output 519 can carry two optical modes.

The third modemux 523 of the second modemux stage is coupled with the first splitter output 531 of the third Y-splitter 521 and the first MM output 517 of the first modemux 524. The third modemux 523 can provide the first MM output 516 of the input splitter 510. The third modemux 523 can “mux” or combine the first portion OS3-1 of the third optical signal OS3 and the combined first portions OS1-1, OS2-1 of the first and second optical signals OS1, OS2 onto the first MM output 516. In one or more examples, in combing the first portion OS3-1 of the third optical signal OS3 and the combined first portions OS1-1, OS2-1 of the first and second optical signals OS1, OS2 onto the first MM output 516, the third modemux 523 can change the optical mode of the first portion OS3-1 of the third optical signal OS3, e.g., from TE0 to TE2, which can be combined with TE0 and TE1 onto the first MM output 516. In this regard, the first MM output 516 can carry three optical modes (e.g., TE0, TE1, TE2). In such examples, the first and second MM WGs 542, 544 of the phase shift section 540 can each be arranged to support three optical modes. Similarly, the first and second MM inputs 552, 554 can each be arranged to support three optical modes.

The fourth modemux 525 of the second modemux stage is coupled with the second splitter output 533 of the third Y-splitter 521 and the second MM output 519 of the second modemux 526. The fourth modemux 525 can provide the second MM output 518 of the input splitter 510. The fourth modemux 525 can “mux” or combine the second portion OS3-2 of the third optical signal OS3 and the combined second portions OS1-2, OS2-2 of the first and second optical signals OS1, OS2 onto the second MM output 518. In one or more examples, in combing the second portion OS3-2 of the third optical signal OS3 and the combined second portions OS1-2, OS2-2 of the first and second optical signals OS1, OS2 onto the second MM output 518, the fourth modemux 525 can change the optical mode of the second portion OS3-2 of the third optical signal OS3, e.g., from TE0 to TE2, which can be combined with TE0 and TE1 onto the second MM output 518. In this regard, the second MM output 518 can carry three optical modes (e.g., TE0, TE1, TE2). Advantageously, the architecture of the optical switch 500 can enable three signal channels to be turned “on” or turned “off” with only one phase shifter, e.g., a single heater. This can reduce the electrical power draw to control the optical switch 500 and/or the apparatus in which the optical switch 500 is implemented. In addition, the architecture of the optical switch 500 can facilitate the use of materials with relatively low RPN, such as silicon nitride for the platform of the optical switch 500. However, the silicon platforms are also applicable.

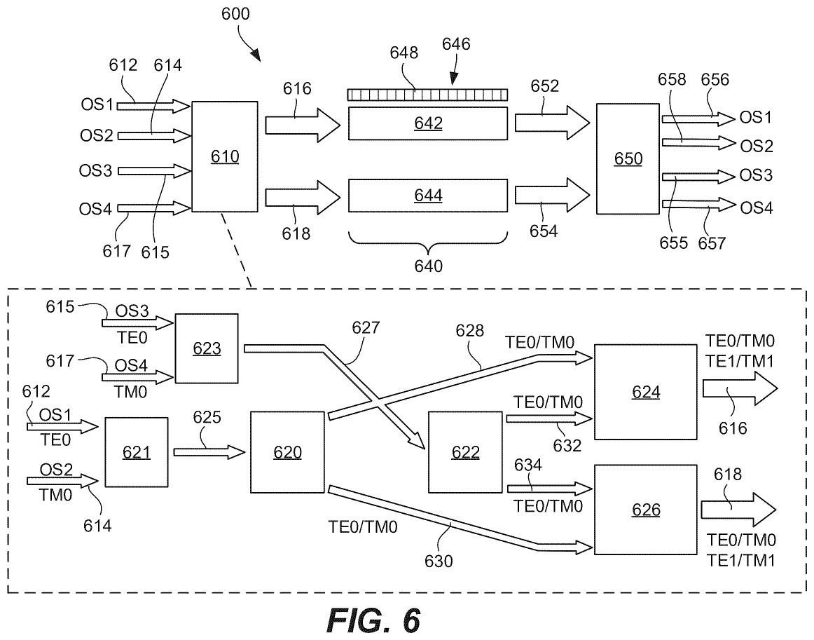

FIG. 6 depicts a schematic block diagram of an optical switch 600 according to one or more aspects of the present disclosure. The optical switch 600 is configured in a similar manner as the optical switch 100, except as otherwise provided below.

The optical switch 600 can include an input splitter 610, a phase shift section 640, and an output combiner 650. In one or more examples, these optical components can be arranged in a silicon nitride layer. The input splitter 610 can include SM inputs, including a first SM input 612, a second SM input 614, a third SM input 615, and a fourth SM input 617. In addition, the input splitter 610 can include MM outputs, including a first MM output 616 and a second MM output 618. The phase shift section 640 can include a first MM WG 642, a second MM WG 644, and a phase shifter 646. The phase shifter 646 can be a thermal phase shifter having a heater 648, for example. The output combiner 650 can include MM inputs, including a first MM input 652 and a second MM input 654 coupled with the first MM WG 642 and the second MM WG 644, respectively. Further, the output combiner 650 can include SM outputs, including a first SM output 656, a second SM output 658, a third SM output 655, and a fourth SM output 657.

In one or more examples, a first optical signal OS1 can be launched into the first SM input 612, a second optical signal OS2 can be launched into the second SM input 614, a third optical signal OS3 can be launched into the third SM input 615, and a fourth optical signal OS4 can be launched into the fourth SM input 617 e.g., at the same time or at different times. In the depicted example of FIG. 6, the first optical signal OS1 has a TE polarization, the second optical signal OS2 has a TM polarization (a transverse magnetic polarization), the third optical signal OS3 has a TE polarization, and the fourth optical signal OS4 has a TM polarization.

In the close-up section of FIG. 6, a schematic block diagram of one example arrangement of the input splitter 610 is depicted. In one or more examples, the input splitter 610 can include a first polarization splitter-rotator (PSR), or first PSR 621, a first Y-splitter 620, a second PSR 623, a second Y-splitter 622, a first modemux 624, and a second modemux 626.

The first PSR 621 can be coupled with the first SM input 612 and the second SM input 614 and can have a PSR output 625. The first PSR 621 can be arranged to translate the TM-and the TE-polarized components of the first and second optical signals OS1, OS2 in opposite directions (i.e., shifted up or shifted down) and/or rotate the polarization state of the first and second optical signals OS1, OS2 by a predefined angle. The first Y-splitter 620 can be coupled with the PSR output 625, and thus, the first Y-splitter 620 can receive the combined first and second signals OS1, OS2, which as noted above, can be translated and/or rotated by the first PSR 621. The first Y-splitter 620 is arranged to split combined first and second signals OS1, OS2, e.g., 50/50, into a first portion and a second portion. The first Y-splitter 620 can have first and second splitter outputs 628, 630.

The second PSR 623 can be coupled with the third SM input 615 and the fourth SM input 617 and can have a PSR output 627. The second PSR 623 can be arranged to translate the TM- and the TE-polarized components of the third and fourth optical signals OS3, OS4 in opposite directions (i.e., shifted up or shifted down) and/or rotate the polarization state of the third and fourth optical signals OS3, OS4 by a predefined angle. The second Y-splitter 622 can be coupled with the PSR output 627, and thus, the second Y-splitter 622 can receive the combined third and fourth signals OS3, OS4, which as noted above, can be translated and/or rotated by the second PSR 623. The second Y-splitter 622 is arranged to split the combined third and fourth signals OS3, OS4, e.g., 50/50, into a first portion and a second portion. The second Y-splitter 622 can have first and second splitter outputs 632, 634.

The first modemux 624 can be coupled with the first splitter output 628 of the first Y-splitter 620 and the first splitter output 632 of the second Y-splitter 622. The first modemux 624 can provide the first MM output 616 of the input splitter 610. The first modemux 624 can “mux” or combine the first portions of the first and second optical signals OS1, OS2 and the first portions of the third and fourth optical signals OS3, OS4 onto the first MM output 616, wherein the first portions of the first and second optical signals OS1, OS2 have different polarizations (e.g., TE and TM polarizations) and the first portions of the third and fourth optical signals OS3, OS4 have different polarizations (e.g., TE and TM polarizations). In one or more examples, in combing the first portions onto the first MM output 616, the first modemux 624 can change the optical mode of the first portions of the third and fourth optical signals OS3, OS4, e.g., from TE0 to TE1 and from TM0 to TM1, while keeping the optical modes of the first portions of the first and second optical signals OS1, OS2 the same, e.g., TE0 and TM0. In this regard, the first MM output 616 can support two different optical modes of each polarization.

The second modemux 626 can be coupled with the second splitter output 630 of the first Y-splitter 620 and the second splitter output 634 of the second Y-splitter 622. The second modemux 626 can provide the second MM output 618 of the input splitter 610. The second modemux 626 can “mux” or combine the second portions of the first and second optical signals OS1, OS2 and the second portions of the third and fourth optical signals OS3, OS4 onto the second MM output 618, wherein the second portions of the first and second optical signals OS1, OS2 have different polarizations (e.g., TE and TM polarizations) and the second portions of the third and fourth optical signals OS3, OS4 have different polarizations (e.g., TE and TM polarizations). In one or more examples, in combing the second portions onto the second MM output 618, the second modemux 626 can change the optical mode of the second portions of the third and fourth optical signals OS3, OS4, e.g., from TE0 to TE1 and from TM0 to TM1, while keeping the optical modes of the second portions of the first and second optical signals OS1, OS2 the same, e.g., TE0 and TM0. In this regard, the second MM output 618 can support two different optical modes of each polarization.

The optical switch 600 can provide certain advantages, benefits, and/or technical effects. For instance, the architecture of the optical switch 600 can enable four signal channels, with at least two of the signal channels being associated with signals having different polarizations, to be turned “on” or turned “off” with a single phase shifter, e.g., a single heater. Accordingly, electrical power can only be supplied to a single power-consuming device to enable control of four signals. This can reduce the electrical power draw to control the optical switch 600 and/or the application in which the optical switch 600 is implemented. Moreover, electrical circuitry components, drivers, etc. can be reduced compared to some optical switches. In addition, the architecture of the optical switch 600 can facilitate the use of materials with relatively low RPN, such as silicon nitride for the platform of the optical switch 600. However, the silicon platforms are also applicable.

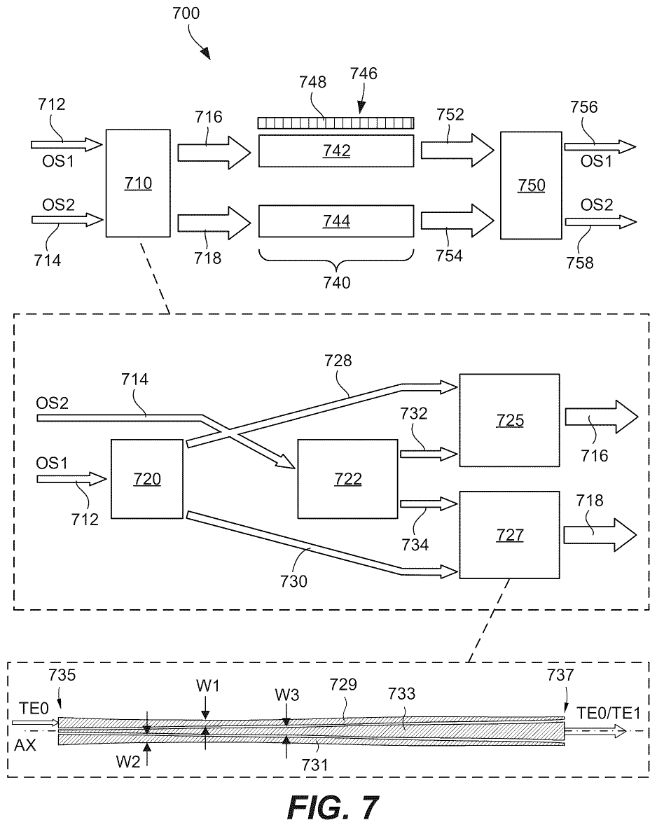

FIG. 7 depicts a schematic block diagram of an optical switch 700 according to one or more aspects of the present disclosure. The optical switch 700 is configured in a similar manner as the optical switch 100, except as otherwise provided below.

The optical switch 700 can include an input splitter 710, a phase shift section 740, and an output combiner 750. In one or more examples, these optical components can be arranged in a silicon nitride layer. The input splitter 710 can include SM inputs, including a first SM input 712 and a second SM input 714. In addition, the input splitter 710 can include MM outputs, including a first MM output 716 and a second MM output 718. The phase shift section 740 can include a first MM WG 742, a second MM WG 744, and a phase shifter 746. The phase shifter 746 can be a thermal phase shifter having a heater 748, for example. The output combiner 750 can include MM inputs, including a first MM input 752 and a second MM input 754 coupled with the first MM WG 742 and the second MM WG 744, respectively. Further, the output combiner 750 can include SM outputs, including a first SM output 756 and a second SM output 758.

In the close-up section of FIG. 7, a schematic block diagram of one example arrangement of the input splitter 710 is depicted. In one or more examples, the input splitter 710 can include a first Y-splitter 720, a second Y-splitter 722, a first MM Y-combiner 725, and a second MM Y-combiner 727.

The first Y-splitter 720 can be coupled with the first SM input 712 and can have first and second splitter outputs 728, 730. The first Y-splitter 720 can be arranged to split an optical signal, such as a first optical signal OS1, into first and second portions, which can be respectively output by the first and second splitter outputs 728, 730. The second Y-splitter 722 can be coupled with the second SM input 714 and can have first and second splitter outputs 732, 734. The second Y-splitter 722 can be arranged to split an optical signal, such as a second optical signal OS2, into first and second portions, which can be respectively output by the first and second splitter outputs 732, 734.

The first MM Y-combiner 725 can be coupled with the first splitter output 728 of the first Y-splitter 720 and the first splitter output 732 of the second Y-splitter 722. The first MM Y-combiner 725 can provide the first MM output 716. The first MM Y-combiner 725 can combine the first portion of the first optical signal OS1 and the first portion of the second optical signal OS2 onto the first MM output 716. In one or more examples, in combing the first portion of the first optical signal OS1 and the first portion of the second optical signal OS2 onto the first MM output 716, the first MM Y-combiner 725 can change the optical mode of the first portion of the second optical signal OS2, e.g., from TE0 to TE1, while keeping the optical mode of the first portion of the first optical signal OS1 the same, e.g., TE0. In this regard, the first MM output 716 can carry two optical modes.

The second MM Y-combiner 727 can be coupled with the second splitter output 730 of the first Y-splitter 720 and the second splitter output 734 of the second Y-splitter 722. The second MM Y-combiner 727 can provide the second MM output 718. The second MM Y-combiner 727 can combine the second portion of the first optical signal OS1 and the second portion of the second optical signal OS2 onto the second MM output 718. In one or more examples, in combing the second portion of the first optical signal OS1 and the second portion of the second optical signal OS2 onto the second MM output 718, the second MM Y-combiner 727 can change the optical mode of the second portion of the second optical signal OS2, e.g., from TE0 to TE1, while keeping the optical mode of the second portion of the first optical signal OS1 the same, e.g., TE0. In this regard, the second MM output 718 can carry two optical modes.

In one or more examples, the first MM Y-combiner 725 and the second MM Y-combiner 727 can be constructed in a same manner. A top view of the second MM Y-combiner 727 is depicted in the close-up section of FIG. 7. As shown, the second MM Y-combiner 727 can include a first input waveguide 729, a second input waveguide 731, and an output waveguide 733 disposed between the first and second input waveguides 731, 733. The waveguides 729, 731, 733 can be formed of silicon, for example. The output waveguide 733 can be a MM WG and the first and second input waveguides 729, 731 can be SM waveguides. The second MM Y-combiner 727 has an input 735 and an output 737.

The second MM Y-combiner 727 is arranged so that an optical signal traveling along the first optical channel can be directed from the first input waveguide 729 to the output waveguide 733, and similarly, so that an optical signal traveling along the second optical channel can be directed from the second input waveguide 731 to the output waveguide 733. In at least some examples, the second MM Y-combiner 727 is symmetric along a center axis AX. In this regard, the first and second input waveguides 729, 731 mirror each other with respect to the center axis AX.

The first input waveguide 729 has a width W1, the second input waveguide 731 has a width W2, and the output waveguide 733 has a width W3. The first and second input waveguides 729, 731 and the output waveguide 733 vary in width along the length of the second MM Y-combiner 727 (the length extending from the input 735 to the output 737). In at least some examples, the width W3 of the output waveguide 733 inverse tapers along the length from the input 735 to the output 737. Further, in at least some examples, the widths W1, W2 of the first and second input waveguides 729, 731 taper, each with a non-linear profile, along the length of the second MM Y-combiner 727 from the input 735 to the output 737. In at least some further examples, the widths W1, W2 of the first and second input waveguides 729, 731 at the input 735 are each greater than the width W3 of the output waveguide 733 at the input 735. At the output 737 of the second MM Y-combiner 727, the width W3 of the output waveguide 733 is greater than the width W1 of the first input waveguide 729 and the width W2 of the second input waveguide 731. The first input waveguide 729 is spaced from the output waveguide 733 by a first gap and the second input waveguide 731 is spaced from the output waveguide 733 by a second gap. In at least some examples, the first gap and the second gap can remain fixed along the length of the second MM Y-combiner 727.

In at least some examples, the first input waveguide 729, the second input waveguide 731, and the output waveguide 733 are arranged such that an optical signal transmitted through the second MM Y-combiner 727 has substantially the same (e.g., within five percent (5%)) optical power at an output of the output waveguide 733 as the optical signal does at an input of either of the first and second input waveguides 729, 731. In this regard, an optical signal traveling through the second MM Y-combiner 727 can have none or negligible insertion loss. Such a result can be achieved passively by the architecture of the waveguides of the second MM Y-combiner 727. For instance, the waveguides 729, 731, 733 of the second MM Y-combiner 727 can be arranged such that a higher order optical mode excited by transmission of an optical signal through the second MM Y-combiner 727 does not radiate away from the waveguides or become “lost” prior to reaching the output 737 of the second MM Y-combiner 727. Accordingly, the higher order optical mode (e.g., TE1) reaches the output 737 of the second MM Y-combiner 727 along with the fundamental optical mode (e.g., TE0) of the optical signal.

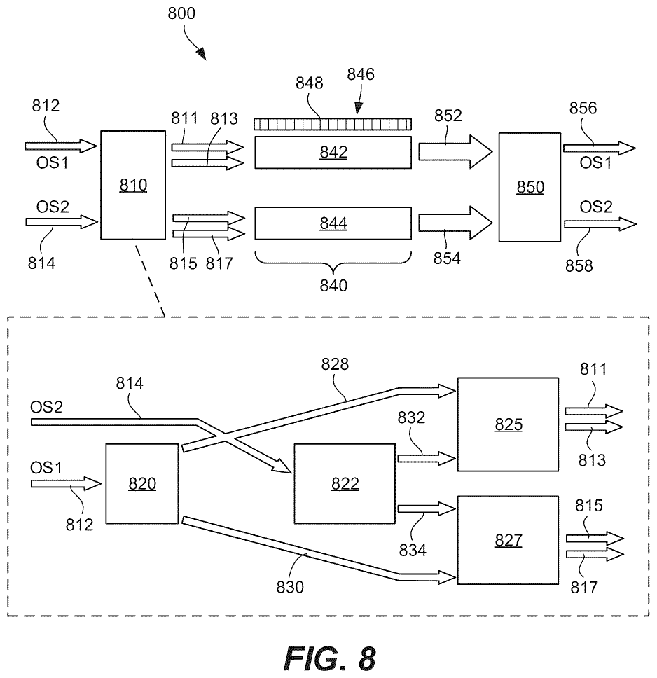

FIG. 8 depicts a schematic block diagram of an optical switch 800 according to one or more aspects of the present disclosure. The optical switch 800 is configured in a similar manner as the optical switch 100, except as otherwise provided below.

The optical switch 800 can include an input splitter 810, a phase shift section 840, and an output combiner 850. In one or more examples, these optical components can be arranged in a silicon nitride layer. The input splitter 810 can include SM inputs, including a first SM input 812 and a second SM input 814. In addition, the input splitter 810 can include SM outputs, including a first SM output 811, a second SM output 813, a third SM output 815, and a fourth SM output 817. The phase shift section 840 can include a first MM WG 842, a second MM WG 844, and a phase shifter 846. The phase shifter 846 can be a thermal phase shifter having a heater 848, for example. The output combiner 850 can include MM inputs, including a first MM input 852 and a second MM input 854 coupled with the first MM WG 842 and the second MM WG 844, respectively. Further, the output combiner 850 can include SM outputs, including a first SM output 856 and a second SM output 858.

In the close-up section of FIG. 8, a schematic block diagram of one example arrangement of the input splitter 810 is depicted. In one or more examples, the input splitter 810 can include a first Y-splitter 820, a second Y-splitter 822, a first coupler 825, and a second coupler 827. The first SM output 811 and the second SM output 813 can be coupled with each other and arranged right next to each other. Similarly, the third SM output 815 and the fourth SM output 817 can be coupled with each other and arranged right next to each other.

The first Y-splitter 820 can be coupled with the first SM input 812 and can have first and second splitter outputs 828, 830. The first Y-splitter 820 can be arranged to split an optical signal, such as a first optical signal OS1, into first and second portions, which can be respectively output by the first and second splitter outputs 828, 830. The second Y-splitter 822 can be coupled with the second SM input 814 and can have first and second splitter outputs 832, 834. The second Y-splitter 822 can be arranged to split an optical signal, such as a second optical signal OS2, into first and second portions, which can be respectively output by the first and second splitter outputs 832, 834.

The first coupler 825, which can be a 2×2 adiabatic coupler, can be coupled with the first splitter output 828 of the first Y-splitter 820 and the first splitter output 832 of the second Y-splitter 822. The first coupler 825 can provide the first SM output 811 and the second SM output 813. The first coupler 825 can change the optical mode of the first portion of the second optical signal OS2, e.g., from TE0 to TE1, while keeping the optical mode of the first portion of the first optical signal OS1 the same, e.g., TE0. In this regard, the first SM output 811 can carry a first optical mode (e.g., TE0) and the second SM output 813 can carry a second optical mode (e.g., TE1). The second coupler 827, which can be a 2×2 adiabatic coupler, can be coupled with the second splitter output 830 of the first Y-splitter 820 and the second splitter output 834 of the second Y-splitter 822. The second coupler 827 can provide the third SM output 815 and the fourth SM output 817. The second coupler 827 can change the optical mode of the second portion of the second optical signal OS2, e.g., from TE0 to TE1, while keeping the optical mode of the second portion of the first optical signal OS1 the same, e.g., TE0. In this regard, the third SM output 815 can carry a first optical mode (e.g., TE0) and the fourth SM output 817 can carry a second optical mode (e.g., TE1).

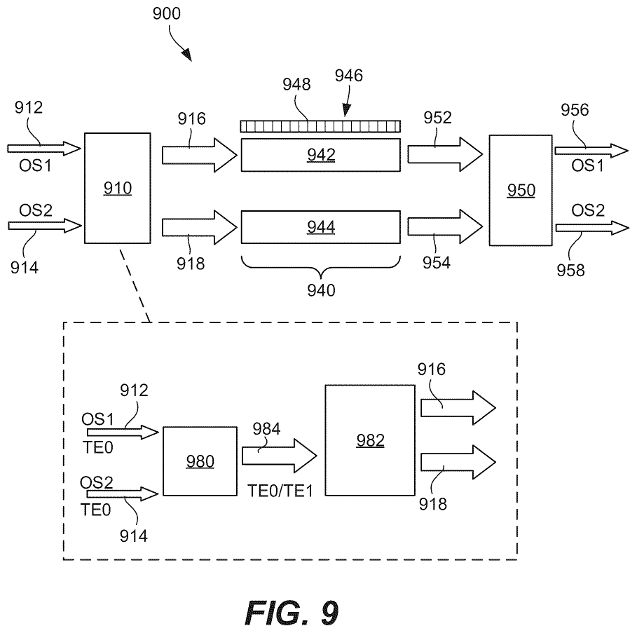

FIG. 9 depicts a schematic block diagram of an optical switch 900 according to one or more aspects of the present disclosure. The optical switch 900 is configured in a similar manner as the optical switch 100, except as otherwise provided below.

The optical switch 900 can include an input splitter 910, a phase shift section 940, and an output combiner 950. In one or more examples, these optical components can be arranged in a silicon nitride layer. The input splitter 910 can include SM inputs, including a first SM input 912 and a second SM input 914. The input splitter 910 can also include MM outputs, including a first MM output 916 and a second MM output 918. The phase shift section 940 can include a first MM WG 942, a second MM WG 944, and a phase shifter 946. The phase shifter 946 can be a thermal phase shifter having a heater 948, for example. The output combiner 950 can include MM inputs, including a first MM input 952 and a second MM input 954 coupled with the first MM WG 942 and the second MM WG 944, respectively. Further, the output combiner 950 can include MM outputs, including a first MM output 956 and a second MM output 958.

In the close-up section of FIG. 9, a schematic block diagram of one example arrangement of the input splitter 910 is depicted. In one or more examples, the input splitter 910 can include a modemux 980 and a MM interferometer 982. The modemux 980 can be coupled with the first SM input 912 and the second SM input 914. The modemux 980 can have a MM output 984. The MM interferometer 982 can be coupled with the MM output 984 of the modemux 980 and can provide the first MM output 916 and the second MM output 918.

In one or more examples, a first optical signal OS1 can be launched into the first SM input 912 and a second optical signal OS2 can be launched into the second SM input 914. The first optical signal OS1 can have a first optical mode (e.g., TE0) and the second optical signal OS2 can have the first optical mode (e.g., TE0) as well. The modemux 980 can “mux” or combine the first optical signal OS1 and the second optical signal OS2 onto the MM output 984. In one or more examples, in combing the first optical signal OS1 and the second optical signal OS2 onto the MM output 984, the modemux 980 can change the optical mode of the second optical signal OS2, e.g., from TE0 to TE1, while keeping the optical mode of the first optical signal OS1 the same, e.g., TE0. In this regard, the MM output 984 can carry two optical modes. The combined first and second signals OS1, OS2 can be carried to the MM interferometer 982, which can split the combined first and second signals OS1, OS2 into a first portion and a second portion, e.g., according to a predefined ratio (e.g., 50/50). The first portion can be output from the input splitter 910 to the first MM WG 942 along the first MM output 916, while the second portion can be output from the input splitter 910 to the second MM WG 944 along the second MM output 918.

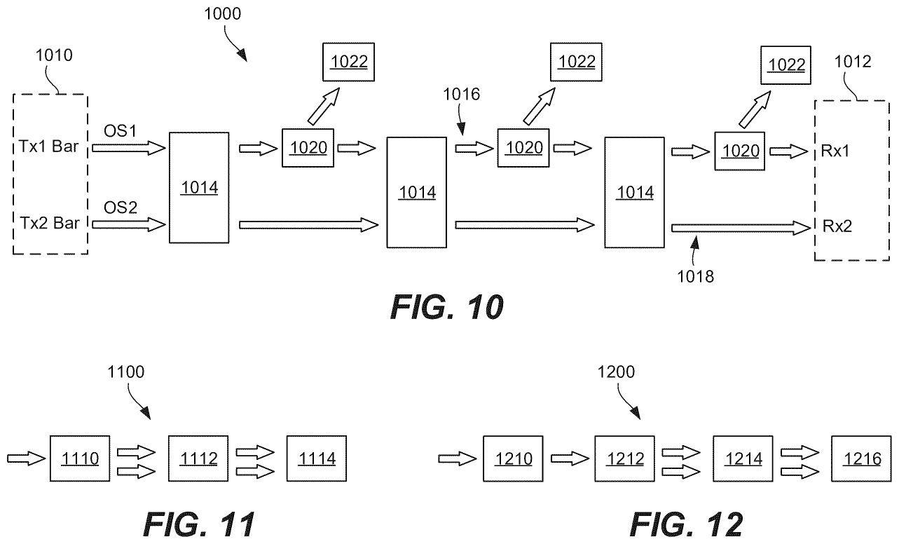

FIG. 10 depicts a schematic block diagram of an apparatus according to one or more aspects of the present disclosure. The apparatus can be an optical transceiver 1000, for example. The optical transceiver 1000 can include a plurality of MM VOAs, which can be configured in a same or similar manner as any of the optical switches disclosed herein.

As depicted in FIG. 10, the optical transceiver 1000 can include a transmitter 1010 having a first transmitter bar Tx1 and a second transmitter bar Tx2. The optical transceiver 1000 can also include a receiver 1012 having a first receiver channel Rx1 and a second receiver channel Rx2. The optical transceiver 1000 can further include a plurality of MM-VOAs 1014 arranged along both a first optical path 1016 and a second optical path 1018. Each of the MM-VOAs 1014 can be configured in a same or similar manner as any one of the optical switches described herein. A plurality of taps 1020 are arranged along the first optical path 1016 and a plurality of photodetectors 1022 are optically coupled with respective ones of the taps 1020. Each one of the MM-VOAs 1014 has an associated tap and photodetector. The taps 1020 can direct a relatively small amount of light to their respective photodetectors 1022, e.g., for determining whether the MM-VOA 1014 associated with a given one of the taps 1020 is in an “on” state or an “off” state.

In one or more examples, a first optical signal OS1 can be launched into the first optical path 1016 at the first transmitter bar Tx1 and a second optical signal OS2 can be launched into the second optical path 1018 at the second transmitter bar Tx2. The first and second optical signals OS1, OS2 can travel through the MM-VOAs 1014 as described herein and the phase shifters of the MM-VOAs 1014 can be strategically controlled to turn “on” or “off” their respective MM-VOAs 1014. When in an “on” state, the MM-VOAs 1014 can allow the first and second optical signals OS1, OS2 to be received by the first and second receiver channels Rx1, Rx2 of the receiver 1012. Advantageously, for the optical transceiver 1000 of FIG. 10, the MM-VOAs 1014 can support control of two optical paths or channels (rather than each optical path having dedicated VOAs).

FIG. 11 depicts a schematic block diagram of an apparatus according to one or more aspects of the present disclosure. The apparatus can be an optical transceiver 1100, for example. The optical transceiver 1100 can include at least one MM-VOA, which can be configured in a same or similar manner as any of the optical switches disclosed herein.

As depicted in FIG. 11, a receiver side of the optical transceiver 1100 can include a polarization splitter grating coupler, or PSGC 1110, an MM-VOA 1112, and a photodetector 1114. The optical transceiver 1100 can be a surface-coupled optical receiver, for example. The PSGC 1110 can receive an optical signal with random polarization, e.g., from an optical fiber. The PSGC 1110 can sort the optical signal into portions by polarization and deliver the sorted portions of the optical signal into two separate SM inputs of the MM-VOA 1112. The MM-VOA 1112 can be configured in a same or similar manner as any one of the optical switches described herein. The phase shifter of the MM-VOA 1112 can be selectively controlled to attenuate the signals passing therethrough to ensure that the optical signal does not overload the photodetector 1114. The photodetector 1114 can detect the light intensity of the optical signal, and can output an electrical signal indicating the light intensity. The electrical signal can be output to a transimpedance amplifier (TIA) of an electrical integrated circuit, for example. Advantageously, for the optical transceiver 1100 of FIG. 11, the MM-VOA 1112 can support control of both the sorted portions (rather than each portion being controlled by dedicated VOAs).

FIG. 12 depicts a schematic block diagram of an apparatus according to one or more aspects of the present disclosure. The apparatus can be an optical transceiver 1200, for example. The optical transceiver 1200 can include at least one MM VOA, which can be configured in a same or similar manner as any of the optical switches disclosed herein.

As depicted in FIG. 12, the receiver side of the optical transceiver 1200 can include an edge coupler 1210, a PSR 1212, an MM-VOA 1214, and a photodetector 1216. The optical transceiver 1200 can be an edge-coupled optical receiver, for example. The edge coupler 1210 can be a fiber array unit (FAU) with at least one optical fiber. An optical signal can be transmitted over the optical fiber and received at the FAU, which can be optically coupled with the PSR 1212. The optical signal can be received by the PSR 1212, which can sort the optical signal into portions by polarization and deliver the sorted portions of the optical signal into two separate SM inputs of the MM-VOA 1214. The MM-VOA 1214 can be configured in a same or similar manner as any one of the optical switches described herein. The phase shifter of the MM-VOA 1214 can be selectively controlled to attenuate the signals passing therethrough to ensure that the optical signal does not overload the photodetector 1216. The photodetector 1216 can detect the light intensity of the optical signal, and can output an electrical signal indicating the light intensity. The electrical signal can be output to a TIA of an electrical integrated circuit, for example. Advantageously, for the optical transceiver 1200 of FIG. 12, the MM-VOA 1214 can support control of both the sorted portions (rather than each portion being controlled by dedicated VOAs).

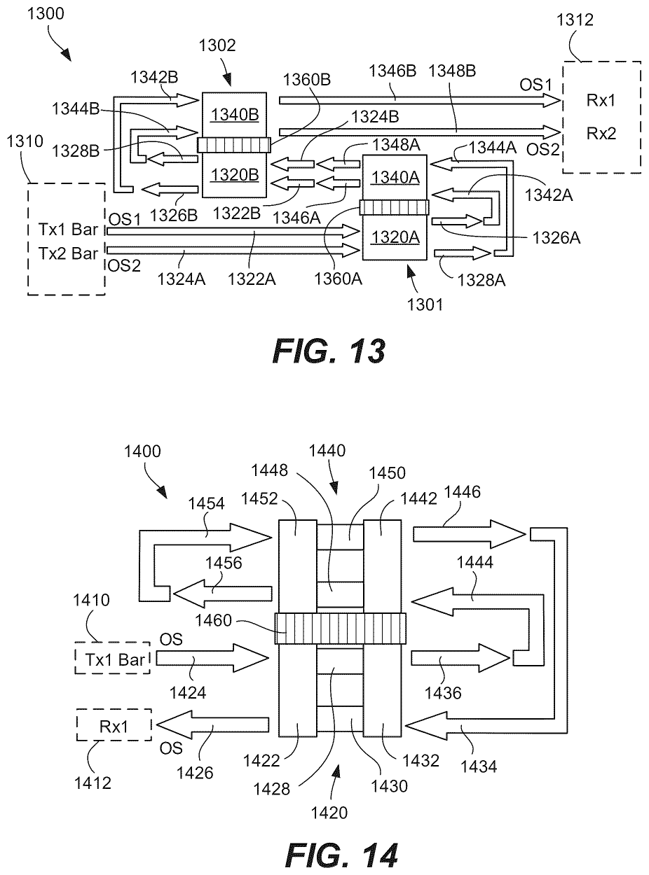

FIG. 13 depicts a schematic block diagram of an apparatus according to one or more aspects of the present disclosure. The apparatus can be an optical transceiver 1300, for example. The optical transceiver 1300 can include a plurality of attenuation units that each include MM VOAs arranged in loopback configurations. The MM VOAs can each be configured in a same or similar manner as any of the optical switches disclosed herein.

As depicted in FIG. 13, the optical transceiver 1300 can include a transmitter 1310 having a first transmitter bar Tx1 and a second transmitter bar Tx2. The optical transceiver 1300 can also include a receiver 1312 having a first receiver channel Rx1 and a second receiver channel Rx2. The optical transceiver 1300 can further include a plurality of MM-VOAs arranged along a first optical path and a second optical path.

The optical transceiver 1300 can include a first unit 1301 having a first MM-VOA 1320A, a second MM-VOA 1340A, and a phase shifter 1360A. The first MM-VOA 1320A has a first input 1322A, a second input 1324A, a first output 1326A, and a second output 1328A. The second MM-VOA 1340A has a first input 1342A, a second input 1344A, a first output 1346A, and a second output 1348A. The phase shifter 1360A can be shared between the first and second MM-VOAs 1320A, 1340A. In at least one example, the phase shifter 1360A can be a thermal phase shifter having a heater. In other examples, the phase shifter 1360A can be another type of phase shifter arranged to induce a phase shift in an optical signal. As shown in FIG. 13, the second MM-VOA 1340A can be arranged in a loopback configuration with respect to the first MM-VOA 1320A so that the phase shifter 1360A is arranged to selectively cause an optical signal traveling through a MM WG of the second MM-VOA 1340A to undergo a phase shift at a same time the phase shifter 1360A causes the optical signal traveling through a MM WG of the first MM-VOA 1320A to undergo a phase shift.

The optical transceiver 1300 can also include a second unit 1302 having a first MM-VOA 1320B (or third MM-VOA), a second MM-VOA 1340B (or fourth MM-VOA), and a phase shifter 1360B. The first MM-VOA 1320B has a first input 1322B, a second input 1324B, a first output 1326B, and a second output 1328B. The second MM-VOA 1340B has a first input 1342B, a second input 1344B, a first output 1346B, and a second output 1348B. The phase shifter 1360B can be shared between the first and second MM-VOAs 1320B, 1340B. In at least one example, the phase shifter 1360B can be a thermal phase shifter having a heater. In other examples, the phase shifter 1360B can be another type of phase shifter arranged to induce a phase shift in an optical signal. As shown in FIG. 13, the second MM-VOA 1340B can be arranged in a loopback configuration with respect to the first MM-VOA 1320B so that the phase shifter 1360B is arranged to selectively cause an optical signal traveling through a MM WG of the second MM-VOA 1340B to undergo a phase shift at a same time the phase shifter 1360B causes the optical signal traveling through a MM WG of the first MM-VOA 1320B to undergo a phase shift.

In one or more examples, a first optical signal OS1 can be launched into the first input 1322A from the first transmitter bar Tx1 and a second optical signal OS2 can be launched into the second input 1324A from the second transmitter bar Tx2. The first and second optical signals OS1, OS2 can travel through the first MM-VOA 1320A, e.g., in a same or similar manner previously described herein with respect to the other optical switches disclosed herein. The phase shifter 1360A can be selectively controlled, e.g., to cause a phase shift in the portions of the first and second optical signals OS1, OS2 passing through a MM WG of the first MM-VOA 1320A. The attenuated first optical signal OS1 can exit the first MM-VOA 1320A by way of the output 1326A and the attenuated second optical signal OS2 can exit the first MM-VOA 1320A by way of the output 1328A. The outputs 1326A, 1328A can be coupled with the inputs 1342A, 1344A, respectively. Thus, the first and second optical signals OS1, OS2 can enter the second MM-VOA 1340A by way of the inputs 1342A, 1344A. The optical signals OS1, OS2 can travel through the second MM-VOA 1340A, e.g., in a same or similar manner previously described herein with respect to the other optical switches disclosed herein. At the same time the phase shifter 1360A is causing the phase shift in the portions of the first and second optical signals OS1, OS2 passing through one of the MM WGs of the first MM-VOA 1320A, the loopback configuration of the first and second MM-VOAs 1320A, 1340A can allow for the phase shifter 1360A to cause a phase shift in the portions of the first and second optical signals OS1, OS2 passing through one of the MM WGs of the second MM-VOA 1340A. The first and second optical signal OS1, OS2 can exit the second MM-VOA 1340A by way of respective outputs 1346A, 1348A. At this stage along the first and second optical paths, the first and second optical signals OS1, OS2 have been attenuated twice by the first MM-VOA 1320A.

After exiting the first unit 1301, the first and second optical signals OS1, OS2 can travel to the second unit 1302. The outputs 1346A, 1348A can be coupled with the inputs 1322B, 1324B, respectively. Thus, the first and second optical signals OS1, OS2 can enter the first MM-VOA 1320B by way of the inputs 1322B, 1324B. The optical signals OS1, OS2 can travel through the first MM-VOA 1320B, e.g., in a same or similar manner previously described herein with respect to the other optical switches disclosed herein. The phase shifter 1360B can be selectively controlled, e.g., to cause a phase shift in the portions of the first and second optical signals OS1, OS2 passing through a MM WG of the first MM-VOA 1320B. The attenuated first optical signal OS1 can exit the first MM-VOA 1320B by way of the output 1326B and the attenuated second optical signal OS2 can exit the first MM-VOA 1320B by way of the output 1328B. The outputs 1326B, 1328B can be coupled with the inputs 1342B, 1344B, respectively. Thus, the first and second optical signals OS1, OS2 can enter the second MM-VOAB 1340B by way of the inputs 1342B, 1344B.

The optical signals OS1, OS2 can travel through the second MM-VOA 1340B, e.g., in a same or similar manner previously described herein with respect to the other optical switches disclosed herein. At the same time the phase shifter 1360B is causing the phase shift in the portions of the first and second optical signals OS1, OS2 passing through one of the MM WGs of the first MM-VOA 1320B, the loopback configuration of the first and second MM-VOAs 1320B, 1340B can allow for the phase shifter 1360B to cause a phase shift in the portions of the first and second optical signals OS1, OS2 passing through one of the MM WGs of the second MM-VOA 1340B. The first and second optical signal OS1, OS2 can exit the second MM-VOA 1340B by way of respective outputs 1346B, 1348B. At this stage along the first and second optical paths, the first and second optical signals OS1, OS2 have each been attenuated four times with the use of only two phase shifters 1360A, 1360B, with the first and second optical signals OS1, OS2 each being attenuated by the first MM-VOA 1320A, the second MM-VOA 1340A, the first MM-VOA 1320B, and the second MM-VOA 1340B. The first receiver channel Rx1 and the second receiver channel Rx2 can receive the four-time attenuated optical signals OS1, OS2, respectively. Advantageously, with the loopback configuration of the first and second MM-VOAs 1320A, 1340A and the loopback configuration of the first and second MM-VOAs 1320B, 1340B and arrangement of the phase shifters 1360A, 1360B, two optical signals can each be attenuated four times with control of two phase shifters.

FIG. 14 depicts a schematic block diagram of an apparatus according to one or more aspects of the present disclosure. The apparatus can be an optical transceiver 1400, for example. The optical transceiver 1400 can include an attenuation unit that includes MM-VOAs arranged in a loopback configuration. The multimode VOAs can each be configured in a same or similar manner as any of the optical switches disclosed herein.

As depicted in FIG. 14, the optical transceiver 1400 can include a transmitter 1410 having a transmitter bar Tx1. The optical transceiver 1400 can also include a receiver 1412 having a receiver channel Rx1. The optical transceiver 1400 can further include a plurality of MM-VOAs arranged along an optical path. In this example, the optical transceiver 1400 can include a first MM-VOA 1420, a second MM-VOA 1440, and a phase shifter 1460. The phase shifter 1460 can be shared between the first and second MM-VOAs 1420, 1440. In at least one example, the phase shifter 1460 can be a thermal phase shifter having a heater. In other examples, the phase shifter 1460 can be another type of phase shifter arranged to induce a phase shift in an optical signal.

The first MM-VOA 1420 can include a splitter-combiner 1422 having an input 1424 and an output 1426. The first MM-VOA 1420 can also include a phase shift section having a first MM WG 1428 and a second MM WG 1430. Further, the first MM-VOA 1420 can include a combiner-splitter 1432 having an input 1434 and an output 1436. The splitter-combiner 1422 can be configured in a similar manner as any of the input splitters described herein and the combiner-splitter 1432 can be configured in a similar manner as any of the output combiners described herein. The second MM-VOA 1440 can include a splitter-combiner 1442 having an input 1444 and an output 1446. The second MM-VOA 1440 can also include a phase shift section having a first MM WG 1448 and a second MM WG 1450. Further, the second MM-VOA 1440 can include a combiner-splitter 1452 having an input 1454 and an output 1456. The splitter-combiner 1442 can be configured in a similar manner as any of the input splitters described herein and the combiner-splitter 1452 can be configured in a similar manner as any of the output combiners described herein.

As further shown in FIG. 14, the output 1436 of the combiner-splitter 1432 of the first MM-VOA 1420 can be coupled with the input 1444 of the splitter-combiner 1442 of the second MM-VOA 1440. The output 1456 of the combiner-splitter 1452 of the second MM-VOA 1440 can be coupled with the input 1454 of the combiner-splitter 1452 of the second MM-VOA 1440. In this regard, an optical signal output by the second MM-VOA 1440 can be directed to reenter the second MM-VOA 1440, e.g., for further attenuation. In addition, the output 1446 of the splitter-combiner 1442 of the second MM-VOA 1440 can be coupled with the input 1434 of the combiner-splitter 1432 of the first MM-VOA 1420. In the example of FIG. 14, the first MM-VOA 1420 and the second MM-VOA 1440 are arranged in a loopback configuration so that the phase shifter 1460 is arranged to selectively cause a signal traveling through the first MM WG 1428 of the first MM-VOA 1420 to undergo a phase shift simultaneously with causing a signal traveling through the first MM WG 1448 of the second MM-VOA 1440 to undergo a phase shift.

In one or more examples, an optical signal OS can be launched into the input 1424 from the first transmitter bar Tx1. The optical signal OS can travel through the first MM-VOA 1420, e.g., in a same or similar manner previously described herein with respect to the other optical switches disclosed herein. The phase shifter 1460 can be selectively controlled, e.g., to cause a phase shift in the optical signal OS passing through the first MM WG 1428. The first optical signal OS1 can exit the first MM-VOA 1420 by way of the output 1436. The output 1436 can be coupled with the input 1444 of the second MM-VOA 1440. Thus, the optical signal OS can enter and pass through the second MM-VOA 1440. The optical signal OS can travel through the second MM-VOA 1440, e.g., in a same or similar manner previously described herein with respect to the other optical switches disclosed herein. At the same time the phase shifter 1460 is causing the phase shift in the optical signal OS passing through the first MM WG 1428 of the first MM-VOA 1420, the loopback configuration of the first and second MM-VOAs 1420, 1440 can allow for the phase shifter 1460 to cause a phase shift in the optical signal OS passing through the first MM WG 1448. The optical signal OS can exit the second MM-VOA 1440 by way of the output 1456. At this stage along the optical path, the optical signal OS has been attenuated twice, once by the first MM-VOA 1420 and once by the second MM-VOA 1440.

After exiting the second MM-VOA 1440, the optical signal OS can reenter the second MM-VOA 1440 by way of the input 1454, which is coupled with the output 1456. The optical signal OS can travel through the second MM-VOA 1440 once again, e.g., in a same or similar manner previously described herein with respect to the other optical switches disclosed herein. The optical signal OS can exit the second MM-VOA 1440 by way of the output 1446 and can reenter the first MM-VOA 1420 by way of the input 1434, which is coupled with the output 1446. The optical signal OS can travel through the first MM-VOA 1420 once again, e.g., in a same or similar manner previously described herein with respect to the other optical switches disclosed herein. The optical signal OS can exit the first MM-VOA 1420 by way of the output 1426. At this stage along the optical path, the optical signal OS has been attenuated four times, twice by the first MM-VOA 1420 and twice by the second MM-VOA 1440. The receiver 1412 can receive the four-time attenuated optical signal. Advantageously, with the loopback configuration of the first and second MM-VOAs 1420, 1440 and arrangement of the phase shifter 1460, an optical signal can be attenuated four times with only a single phase shifter.

In the current disclosure, reference is made to various embodiments. However, the scope of the present disclosure is not limited to the specifically described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

In view of the foregoing, the scope of the present disclosure is determined by the claims that follow.

We claim:

1. An optical switch, comprising:
an input splitter arranged to split a first optical signal input into a first single mode input onto first and second multimode outputs and to split a second optical signal input into a second single mode input onto the first and second multimode outputs;
a phase shift section having a first multimode waveguide coupled with the first multimode output, a second multimode waveguide coupled with the second multimode output, and a phase shifter arranged to selectively cause a multimode optical signal traveling through the first multimode waveguide to undergo a phase shift relative to a multimode optical signal traveling through the second multimode waveguide, the multimode optical signals each including a portion of the first optical signal and a portion of the second optical signal; and
an output combiner arranged to receive the multimode optical signals from the first and second multimode waveguides and to recombine the first optical signal onto a first single mode output and to recombine the second optical signal onto a second single mode output.

2. The optical switch of claim 1, wherein the input splitter comprises:
a first Y-splitter coupled with the first single mode input and having first and second splitter outputs;
a second Y-splitter coupled with the second single mode input and having first and second splitter outputs;
a first modemux coupled with the first splitter output of the first Y-splitter and the first splitter output of the second Y-splitter; and
a second modemux coupled with the second splitter output of the first Y-splitter and the second splitter output of the second Y-splitter.

3. The optical switch of claim 2, wherein the second single mode input crosses the first splitter output of the first Y-splitter or the second splitter output of the first Y-splitter.

4. The optical switch of claim 2, wherein the first modemux provides the first multimode output and the second modemux provides the second multimode output.

5. The optical switch of claim 1, wherein the phase shifter is a thermal phase shifter having a heater.

6. The optical switch of claim 1, wherein the phase shifter is an electro-optic phase shifter.

7. The optical switch of claim 1, wherein the output combiner comprises:
a first modemux coupled with the first multimode waveguide and having first and second modemux outputs;
a second modemux coupled with the second multimode waveguide and having first and second modemux outputs;
a first coupler coupled with the first modemux output of the first modemux and the first modemux output of the second modemux, wherein the first coupler has first mode outputs, including a first mode thru output and a first mode cross output; and
a second coupler coupled with the second modemux output of the first modemux and the second modemux output of the second modemux, wherein the second coupler has second mode outputs, including a second mode thru output and a second mode cross output,
wherein the first single mode output corresponds to the first mode cross output and the second single mode output corresponds to the second mode cross output.

8. The optical switch of claim 1, wherein the input splitter comprises:
a third single mode input;
a first Y-splitter coupled with the first single mode input and having first and second splitter outputs;
a second Y-splitter coupled with the second single mode input and having first and second splitter outputs;
a third Y-splitter coupled with the third single mode input and having first and second splitter outputs;
a first stage having (i) a first modemux coupled with the first splitter output of the first Y-splitter and the first splitter output of the second Y-splitter; and (ii) a second modemux coupled with the second splitter output of the first Y-splitter and the second splitter output of the second Y-splitter; and
a second stage having (i) a first modemux coupled with a first multimode output of the first modemux of the first stage and the first splitter output of the third Y-splitter; and (ii) a second modemux coupled with the second multimode output of the second modemux of the first stage and the second splitter output of the third Y-splitter.

9. The optical switch of claim 1, wherein the input splitter comprises:
a third single mode input;
a fourth single mode input;
a first polarization splitter-rotator (PSR) coupled with the first single mode input and the second single mode input and having a first PSR output;
a first Y-splitter coupled with the first PSR output and having first and second splitter outputs;
a second PSR coupled with the third single mode input and the fourth single mode input and having a second PSR output;
a second Y-splitter coupled with the second PSR output and having first and second splitter outputs;
a first modemux coupled with the first splitter output of the first Y-splitter and the first splitter output of the second Y-splitter; and
a second modemux coupled with the second splitter output of the first Y-splitter and the second splitter output of the second Y-splitter.

10. The optical switch of claim 1, wherein the input splitter comprises:
a first Y-splitter coupled with the first single mode input and having first and second splitter outputs;
a second Y-splitter coupled with the second single mode input and having first and second splitter outputs;
a first multimode Y-combiner coupled with the first splitter output of the first Y-splitter and the first splitter output of the second Y-splitter; and
a second multimode Y-combiner coupled with the second splitter output of the first Y-splitter and the second splitter output of the second Y-splitter, and
wherein the first multimode Y-combiner and the second multimode Y-combiner each comprise:
a first input waveguide;
a second input waveguide; and
an output waveguide disposed between the first and second input waveguides,
wherein the first input waveguide, the second input waveguide, and the output waveguide are arranged such that an optical signal transmitted through the first multimode Y-combiner or the second multimode Y-combiner has substantially the same optical power at an output of the output waveguide as the optical signal does at an input of either of the first and second input waveguides.

11. The optical switch of claim 1, wherein the input splitter comprises:
a first Y-splitter coupled with the first single mode input and having first and second splitter outputs;
a second Y-splitter coupled with the second single mode input and having first and second splitter outputs;
a first adiabatic coupler coupled with the first splitter output of the first Y-splitter and the first splitter output of the second Y-splitter, wherein the first adiabatic coupler has first and second outputs coupled with the first multimode waveguide; and
a second adiabatic coupler coupled with the second splitter output of the first Y-splitter and the second splitter output of the second Y-splitter, wherein the second adiabatic coupler has first and second outputs coupled with the second multimode waveguide.

12. The optical switch of claim 1, wherein the input splitter comprises:
a first modemux coupled with the first single mode input and a second single mode input, the first modemux having a multimode output; and
a multimode interferometer coupled with the multimode output of the first modemux and providing the first multimode output and the second multimode output.

13. An apparatus, comprising:
a first multimode variable optical attenuator (MM-VOA);
a second MM-VOA, and
wherein the first MM-VOA and the second MM-VOA each comprise:
an input splitter arranged to split a first optical signal input into a first single mode input onto first and second multimode outputs and to split a second optical signal input into a second single mode input onto the first and second multimode outputs;
a phase shift section comprising a first multimode waveguide coupled with the first multimode output, and a second multimode waveguide coupled with the second multimode output; and
an output combiner arranged to recombine the first optical signal onto a first single mode output and to recombine the second optical signal onto a second single mode output; and
a phase shifter shared by the first MM-VOA and the second MM-VOA and arranged to selectively cause a multimode signal traveling through the first multimode waveguide of the first MM-VOA and a multimode signal traveling through the first multimode waveguide of second MM-VOA to each undergo a phase shift, the multimode signal traveling through the first multimode waveguide of the first MM-VOA including portions of the first and second optical signals input into the first and second single mode inputs of the first MM-VOA and the multimode signal traveling through the first multimode waveguide of the second MM-VOA including portions of the first and second optical signals input into the first and second single mode inputs of the second MM-VOA.

14. The apparatus of claim 13, wherein the first single mode output of the first MM-VOA is coupled with the first single mode input of the second MM-VOA and the second single mode output of the first MM-VOA is coupled with the second single mode input of the second MM-VOA.

15. The apparatus of claim 14, wherein the second MM-VOA is arranged in a loopback configuration with respect to the first MM-VOA so that the phase shifter is arranged to selectively cause the multimode signal traveling through the first multimode waveguide of the second MM-VOA to undergo a phase shift at a same time the phase shifter causes the multimode signal traveling through the first multimode waveguide of the first MM-VOA to undergo the phase shift.

16. The apparatus of claim 15, wherein the first MM-VOA and the second MM-VOA form a first unit, and wherein the apparatus further comprises:
a second unit having a third MM-VOA, a fourth MM-VOA, and a phase shifter, the third MM-VOA comprising:
an input splitter having a first single mode input and a second single mode input, and
wherein the first single mode input of the third MM-VOA is coupled with the first single mode output of the second MM-VOA and the second single mode input of the third MM-VOA is coupled with the second single mode output of the second MM-VOA.

17. The apparatus of claim 16, wherein the third MM-VOA and the fourth MM-VOA are arranged in a loopback configuration so that the phase shifter of the second unit is arranged to selectively cause a multimode signal traveling through a multimode waveguide of the third MM-VOA to undergo a phase shift at a same time the phase shifter of the second unit causes a multimode signal traveling through a multimode waveguide of the fourth MM-VOA to undergo a phase shift.

18. The apparatus of claim 13, wherein the first MM-VOA and the second MM-VOA form an attenuation unit, and wherein the apparatus further comprises:
a transmitter; and
a receiver,
wherein the attenuation unit is arranged along an optical path between the transmitter and the receiver.

19. An apparatus, comprising:
a phase shifter;
a first multimode variable optical attenuator (MM-VOA); and
a second MM-VOA,
wherein the first MM-VOA and the second MM-VOA each comprise:
a splitter-combiner having an input and an output;
a phase shift section having a first multimode waveguide and a second multimode waveguide; and
a combiner-splitter having an input and an output,
wherein: (i) the output of the combiner-splitter of the first MM-VOA is coupled with the input of the splitter-combiner of the second MM-VOA, (ii) the output of the splitter-combiner of the second MM-VOA is coupled with the input of the splitter-combiner of the second MM-VOA, and (iii) the output of the combiner-splitter of the second MM-VOA is coupled with the input of the combiner-splitter of the first MM-VOA,
wherein the first MM-VOA and the second MM-VOA are arranged in a loopback configuration so that the phase shifter is arranged to selectively cause a signal traveling through the first multimode waveguide of the first MM-VOA to undergo a phase shift simultaneously with causing a signal traveling through the first multimode waveguide of the second MM-VOA to undergo a phase shift.

20. The apparatus of claim 19, wherein the first MM-VOA and the second MM-VOA form an attenuation unit, and wherein the apparatus further comprises:
a transmitter; and
a receiver,
wherein the attenuation unit is arranged along an optical path between the transmitter and the receiver.
